(19) United States
(12) Patent Application Publication
(10) Pub. No.: US 2002/0009137 A1
(43) Pub. Date: Jan. 24, 2002

(54) Three-dimensional video broadcasting system

(76) Inventors: John E. Nelson, Palos Verdes, CA (US); Bernard J. Butler-Smith, Agoura Hills, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/775,378

(22) Filed: Feb. 1, 2001

Related U.S. Application Data
(60) Provisional application No. 60/179,455, filed on Feb. 1, 2000.
(60) Provisional application No. 60/179,712, filed on Feb. 1, 2000.
(60) Provisional application No. 60/228,364, filed on Aug. 28, 2000.
(60) Provisional application No. 60/228,392, filed on Aug. 28, 2000.

(51) Int. Cl. H04N 7/12

(52) U.S. Cl. 375/240.1

(57) ABSTRACT

A 3D video broadcasting system includes a video stream compressor used to generate a base stream and an enhancement stream using a base stream encoder and an enhancement stream encoder, respectively. The base stream includes either right view images or left view images, and is encoded and decoded independently of the enhancement stream using MPEG-2 standard. The enhancement stream includes the view images not included in the base stream, and is dependent upon the base stream for encoding and decoding. The base stream encoder provides I-pictures to the enhancement stream encoder for disparity estimation and compensation during bi-directional encoding and decoding of the enhancement stream. In addition, for bi-directional encoding and decoding, decoded enhancement stream pictures are used for motion estimation and compensation. The video stream compressor can be used to compress right and left view video streams from two video cameras or from a single video camera generated using a 3D lens system.

### CROSS-REFERENCE TO RELATED APPLICATIONS

This application claims the priority of U.S. Provisional Application No. 60/179,455 entitled “Binocular Lens System for 3-D Video Transmission” filed Feb. 1, 2000; U.S. Provisional Application No. 60/179,712 entitled “3-D Video Capture/Transmission System” filed Feb. 1, 2000; U.S. Provisional Application No. 60/228,364 entitled “3-D Video Capture/Transmission System” filed Aug. 28, 2000; and U.S. Provisional Application No. 60/228,392 entitled “Binocular Lens System for 3-D Video Transmission” filed Aug. 28, 2000; the contents of all of which are fully incorporated herein by reference. This application contains subject matter related to the subject matter disclosed in the U.S. patent application (Attorney Docket No. 41535/WGM/Z51) entitled “Binocular Lens System for Three-Dimensional Video Transmission” filed Feb. 1, 2001, the contents of which are fully incorporated herein by reference.

### FIELD OF THE INVENTION

This invention is related to a video broadcasting system, and particularly to a method and apparatus for capturing, transmitting and displaying three-dimensional (3D) video using a single camera.

### BACKGROUND OF THE INVENTION

Transmission and reception of digital broadcasting is gaining momentum in the broadcasting industry. It is often desirable to provide 3D video broadcasting since it is often more realistic to the viewer than the two-dimensional (2D) counterpart.

Television broadcasting contents in 3D conventionally have been provided using a system with two cameras in a dual camera approach. In addition, processing of the conventional 3D images has been performed non real-time. The use of multiple cameras to capture 3D video and the method of processing video images non real-time typically are not compatible with real-time video production and transmission practices.

It is desirable to provide a 3D video capture/transmission system which allows for minor changes to existing equipment and procedures to achieve the broadcast of a real-time stereo video stream which can be decoded either as a standard definition video stream or, with low-cost add-on equipment, to generate a 3D video stream.

### SUMMARY OF THE INVENTION

In one embodiment of this invention, a video compressor is provided. The video compressor includes a first encoder and a second encoder. The first encoder receives and encodes a first video stream. The second encoder receives and encodes a second video stream. The first encoder provides information related to the first video stream to the second encoder to be used during the encoding of the second video stream.

In another embodiment of this invention, a method of compressing video is provided. First and second video streams are received. A first video stream is encoded. Then, the second video stream is encoded using information related to the first video stream.

In yet another embodiment of this invention, a 3D video displaying system is provided. The 3D video displaying system includes a demultiplexer, a first decompressor and a second decompressor. The demultiplexer receives a compressed 3D video stream, and extracts a first compressed video stream and a second compressed video stream from the compressed 3D video stream. The first decompressor decodes the first compressed video stream to generate a first video stream. The second decompressor decodes the second compressed video stream using information related to the first compressed video stream to generate a second video stream.

In still another embodiment of this invention, a method of processing a compressed 3D video stream is provided. The compressed 3D video stream is received. The compressed 3D video stream is demultiplexed to extract a first compressed video stream and a second compressed video stream. The first compressed video stream is decoded to generate a first video stream. The second compressed video stream is decoded using information related to the first compressed video stream to generate a second video stream.

In a further embodiment of this invention, a 3D video broadcasting system is provided. The 3D video broadcasting system includes a video compressor for receiving right and left view video streams, and for generating a compressed 3D video stream. The 3D video broadcasting system also includes a set-top receiver for receiving the compressed 3D video stream and for generating a 3D video stream. The compressed video stream includes a first compressed video stream and a second compressed video stream, and the second compressed video stream has been encoded using information from the first compressed video stream.

In a still further embodiment, a 3D video broadcasting system is provided. The 3D video broadcasting system includes compressing means for receiving and encoding right and left view video streams to generate a compressed 3D video stream. The 3D video broadcasting system also includes decompressing means for receiving and decoding the compressed 3D video stream to generate a 3D video stream. The compressed 3D video stream comprises a first compressed video stream and a second compressed video stream. The second compressed video stream has been encoded using information from the first compressed video stream.

### BRIEF DESCRIPTION OF THE DRAWINGS

These and other aspects of the invention may be understood by reference to the following detailed description, taken in conjunction with the accompanying drawings, which are briefly described below.

FIG. 1 is a block diagram of a 3D video broadcasting system according to one embodiment of this invention;

FIG. 2 is a block diagram of a 3D lens system according to one embodiment of this invention;

FIG. 3 is a schematic diagram of a shutter in one embodiment of the invention;

FIG. 4 is a schematic diagram illustrating mirror control components in one embodiment of the invention;

FIG. 5 is a timing diagram of micro mirror synchronization in one embodiment of the invention;

FIG. 6 is a schematic diagram of a shutter in another embodiment of the invention;

FIG. 7 is a schematic diagram showing a rotating disk used in the shutter of FIG. 6;

FIG. 8 is a block diagram illustrating functions and interfaces of control electronics in one embodiment of the invention;

FIG. 9 is a block diagram of a video stream formatter in one embodiment of the invention;

FIG. 10 is a flow diagram for formatting an HD digital video stream in one embodiment of the invention;

FIG. 11 is a block diagram of a video compressor in one embodiment of the invention;

FIG. 12 is a block diagram of a motion/disparity compensated coding and decoding system in one embodiment of the invention;

FIG. 13 is a block diagram of a base stream encoder in one embodiment of the invention;

FIG. 14 is a block diagram of an enhancement stream encoder in one embodiment of the invention;

FIG. 15 is a block diagram of a base stream decoder in one embodiment of the invention; and

FIG. 16 is a block diagram of an enhancement stream decoder in one embodiment of the invention.

### DETAILED DESCRIPTION

I. 3D Video Broadcasting System Overview

A 3D video broadcasting system, in one embodiment of this invention, enables production of digital stereoscopic video with a single camera in real-time for digital television (DTV) applications. In addition, the coded digital video stream produced by this system preferably is compatible with current digital video standards and equipment. In other embodiments, the 3D video broadcasting system may also support production of non-standard video streams for two-dimensional (2D) or 3D applications. In still other embodiments, the 3D video broadcasting system may also support generation, processing and display of analog video signals and/or any combination of analog and digital video signals.

The 3D video broadcasting system, in one embodiment of the invention, allows for minor changes to existing equipment and procedures to achieve the broadcast of a stereo video stream which may be decoded either as a Standard Definition (SD) video stream using standard equipment or as a 3D digital video system using low-cost add-on equipment in addition to the standard equipment. In other embodiments, the standard equipment may not be needed when all video signal processing is done using equipment specifically developed for those embodiments. The 3D video broadcasting system may also allow for broadcasting of a stereo video stream, which may be decoded either as a 2D High Definition (HD) video stream or a 3D HD video stream.

The 3D video broadcasting system, in one embodiment of this invention, processes a right view video stream and a left view video stream which have a motion difference based on the field temporal difference and the right-left view difference (disparity) based on the viewpoint differences. Disparity is the dissimilarity in views observed by the left and right eyes forming the human perception of the viewed scene, and provides stereoscopic visual cues. The motion difference and the disparity difference preferably are used to result in more efficient coding of a compressed 3D video stream.

The 3D video broadcasting system may be used with time-sequential stereo field display, which preferably is compatible with the large installed base of NTSC television receivers. The 3D video broadcasting system also may be used with time-simultaneous display with dual view 3D systems. In the case of the time-sequential viewing mode, alternate left and right video fields preferably are presented to the viewer by means of actively shuttered glasses, which are synchronized with the alternate interlaced fields (or alternate frames) produced by standard televisions. For example, conventional Liquid Crystal Display (LCD) shuttered glasses may be used during the time-sequential viewing mode. The time-simultaneous dual view 3D systems, for example, may include miniature right and left monitors mounted on an eyeglass-type frame for viewing right and left field views simultaneously.

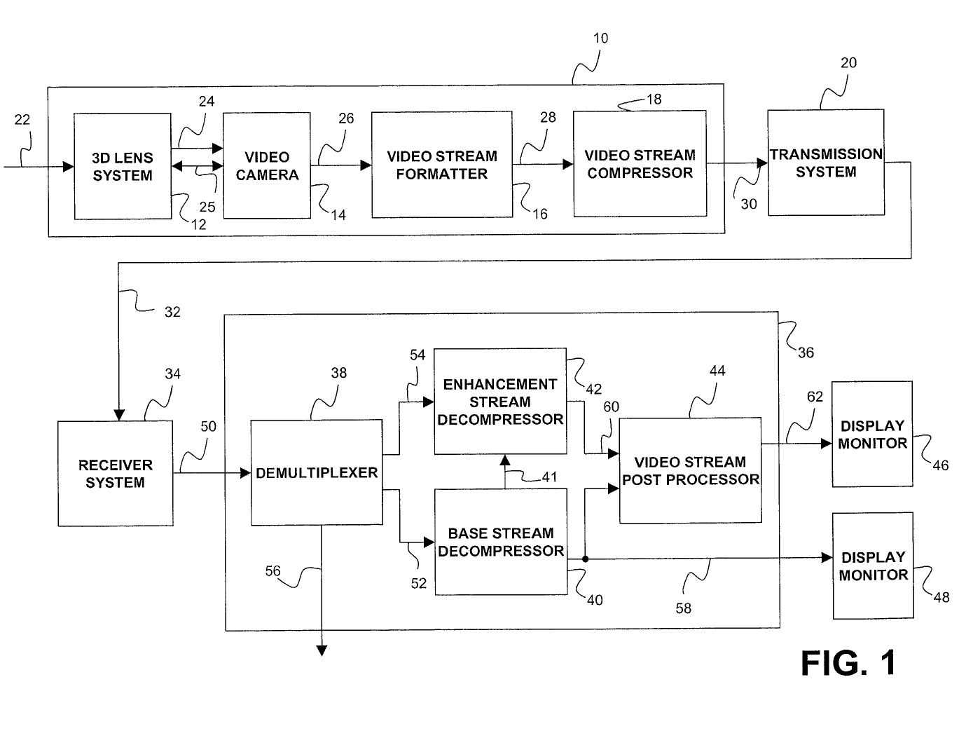

The 3D video broadcasting system in one embodiment of this invention is illustrated in FIG. 1. The 3D video broadcasting system includes a 3D video generation system 10 and a set-top receiver 36, which may also be referred to as a video display system. The video generation system 10 is used by a content provider to capture video images and to broadcast the captured video images. The set-top receiver 36 preferably is implemented in a set-top box, allowing viewers to view the captured video images in 2D or 3D using SD television (SDTV) and/or HD television (HDTV).

The 3D video generation system 10 includes a 3D lens system 12, a video camera 14, a video stream formatter 16 and a video stream compressor 18. The video stream formatter 16 may also be referred to as a video stream pre-processor. The 3D lens system 12 preferably is compatible with conventional HDTV cameras used in the broadcasting industry. The 3D lens system may also be compatible with various different types of SDTV and other HDTV video cameras. The 3D lens system 12 preferably includes a binocular lens assembly to capture stereoscopic video images and a zoom lens assembly to provide conventional zooming capabilities. The binocular lens assembly includes left and right lenses for stereoscopic image capturing. Zooming in the 3D lens system may be controlled manually and/or automatically using lens control electronics.

The 3D lens system 12 preferably receives optical images 22 using the binocular lens assembly, and thus, the optical images 22 preferably include left view images and right view images, respectively, from the left and right lenses of the binocular lens assembly. The left and right view images preferably are combined in the binocular lens assembly using a shutter so that the zoom lens assembly preferably receives a single stream of optical images 24.

The 3D lens system 12 preferably transmits the stream of optical images 24 to the video camera 14, which may include conventional or non-conventional HD and/or SD television cameras. The 3D lens system 12 preferably receives power, control and other signals from the video camera 14 over a camera interface 25. The control signals transmitted to the 3D lens system can include video sync signals to synchronize the shuttering action of the shutter in the binocular lens assembly to the video camera so as to combine the left and right view images. In other embodiments, the control signals and/or power may be provided by an electronics assembly located outside of the video camera 14.

The video camera 14 preferably receives a single stream of optical images 24 from the 3D lens system 12, and transmits a video stream 26 to the video stream formatter 16. The video stream 26 preferably includes an HD digital video stream. Further, the video stream 26 preferably includes at least 60 fields/second of video images. In other embodiments, the video stream 26 may include HD and/or SD video streams that meet one or more of various video stream format standards. For example, the video stream may include one or more of ATSC (Advanced Television Systems Committee) HDTV video streams or digital video streams. In other embodiments, the video stream 26 may also include one or more analog signals, such as, for example, NTSC, PAL, Y/C(S-Video), SECAM, RGB, YP_{R}P_{B}, YC_{R}C_{B} signals.

The video stream formatter 16, in one embodiment of this invention, preferably includes a video stream processing unit that receives the video stream 26 and formats, e.g., pre-processes the video stream and transmits it as a formatted video stream 28 to the video stream compressor 18. For example, the video stream formatter 16 may convert the video stream 26 into a digital stereoscopic pair of video streams at SDTV or HDTV resolution. Preferably, the video stream formatter 16 provides the digital stereoscopic pair of video streams in the formatted video stream 28. In other embodiments, the video stream formatter may feed through the received video stream 26 as the video stream 28 without formatting. In still other embodiments, the video stream formatter may scale and/or scan rate convert the video images in the video stream 26 to provide as the formatted video stream 28. Further, when the video stream 26 includes analog video signals, the video stream formatter may digitize the analog video signals prior to formatting them.

The video stream formatter 16 also may provide analog or digital video outputs in 2D and/or 3D to monitor video quality during production. For example, the video stream formatter may provide an HD video stream to an HD display to monitor the quality of HD images. For another example, the video stream formatter may provide a stereoscopic pair of video streams or a 3D video stream to a 3D display to monitor the quality of 3D images. The video stream formatter 16 also may transmit audio signals, i.e., an electrical signal representing audio, to the video stream compressor 18. The audio signals, for example, may have been captured using a microphone (not shown) coupled to the video camera 14.

The video stream compressor 18 may include a compression unit that compresses the formatted video stream 28 into a pair of packetized video streams. The compression unit preferably generates a base stream that conforms to MPEG standard using a standard MPEG encoder. Video signal processing using MPEG algorithms is well known to those skilled in the art. The compression unit preferably also generates an enhancement stream. The enhancement stream preferably is used with the base stream to produce 3D television signals.

An MPEG video stream typically includes Intra pictures (I-pictures), Predictive pictures (P-pictures) and/or Bi-directional pictures (B-pictures). The I-pictures, P-pictures and B-pictures may include frames and/or fields. For example, the base stream may include information from left view images while the enhancement stream may include information from right view images, or vice versa. When the left view images are used to generate the base stream, I-frames (or fields) from the base stream preferably are used as reference images to generate P-frames (or fields) and/or B-frames (or fields) for the enhancement stream. Thus, the enhancement stream preferably uses the base stream as a predictor. For example, motion vectors for the enhancement stream's P-pictures and B-pictures preferably are generated using the base stream's I-pictures as the reference images.

An MPEG-2 encoder preferably is used for encoding the base stream to provide in an MPEG-2 base channel. The enhancement stream preferably is provided in an MPEG-2 auxiliary channel. The enhancement stream may be encoded using a modified MPEG-2 encoder, which preferably receives and uses I-pictures from the base stream as reference images to generate the enhancement stream. In other embodiments, other MPEG encoders, e.g., MPEG encoder or MPEG-4 encoder, may be used to encode the base and/or enhancement streams. In still other embodiments, non-conventional encoders may be used to generate both the base stream and the enhancement stream. In the described embodiments, I-pictures from the base stream preferably are used as reference images to encode and decode the enhancement stream.

The video stream compressor 18 preferably also includes a multiplexer for multiplexing the base and enhancement streams into a compressed 3D video stream 30. In other embodiments, the multiplexer may also be included in the 3D video generation system 10 outside of the video stream compressor 18 or in a transmission system 20. This use of the single compressed 3D video stream preferably enables simultaneous broadcasting of standard and 3D television signals using a single video stream. The compressed 3D video stream 30 may also be referred to as a transport stream or as an MPEG Transport stream.

The video stream compressor 18 preferably also compresses audio signals provided by the video stream formatter 16, if any. For example, the video stream compressor 18 may compress and packetize the audio signals into an audio stream that meet ATSC digital audio compression (AC-3) standard or any other suitable audio compression standard. When the audio stream is generated, the multiplexer preferably also multiplexes the audio stream with the base and enhancement streams.

The compressed 3D video stream 30 preferably is transmitted to one or more receivers, e.g., set-top receivers, via the transmission system 20. The transmission system 20 may transmit the compressed 3D video stream over digital and/or analog transmission media 32, such as, for example, satellite links, cable channels, fiber optic cables, ISDN, DSL, PSTN and/or any other media suitable for transmitting digital and/or analog signals. The transmission system, for example, may include an antenna for wireless transmission.

For another example, the transmission media 32 may include multiple links, such as, for example, a link between an event venue and a broadcast center and a link between the broadcast center and a viewer site. In this scenario, the video images preferably are captured using the video generation system 10 and transmitted to the broadcast center using the transmission system 20. At the broadcast center, the video images may be processed, multiplexed and/or selected for broadcasting. For example, graphics, such as station identification, may be overlaid on the video images; or other contents, such as, for example, commercials or other program contents, may be multiplexed with the video images from the video generation system 10. Then, the receiver system 34 preferably receives a broadcasted compressed video stream over the transmission media 32. The broadcasted compressed video stream may include the compressed 3D video stream 30 in addition to other multiplexed contents.

The compressed 3D video stream 30 transmitted over the transmission media 32 preferably is received by a set-top receiver 36 via a receiver system 34. The set-top receiver 36 may be included in a standard set-top box. The receiver system 34, for example, preferably is capable of receiving digital and/or analog signals transmitted by the transmission system 20. The receiver system 34, for example, may include an antenna for reception of the compressed 3D video stream. The receiver system 34 preferably transmits the compressed 3D video stream 50 to the set-top receiver 36. The received compressed 3D video stream 50 preferably is similar to the transmitted compressed 3D video stream 30, with differences attributable to attenuation, waveform deformation, error, and the like in the transmission system 20, the transmission media 32 and/or the receiver system 34.

The set-top receiver 36 preferably includes a demultiplexer 38, a base stream decompressor 40, an enhancement stream decompressor 42 and a video stream post processor 44. The enhancement stream decompressor 42 and the base stream decompressor 40 may also be referred to as an enhancement stream decoder and a base stream decoder, respectively. The demultiplexer 38 preferably receives the compressed 3D video stream 50 and demultiplexes it into a base stream 52, an enhancement stream 54 and/or an audio stream 56.

As discussed earlier, the base stream 52 preferably includes an independently coded video stream of either the right view or the left view. The enhancement stream 54 preferably includes an additional stream of information used together with information from the base stream 52 to generate the remaining view (either left or right depending on the content of the base stream) for 3D viewing.

The base stream decompressor 40, in one embodiment of this invention, preferably includes a standard MPEG-2 decoder for processing ATSC compatible compressed video streams. In other embodiments, the base stream decompressor 40 may include other types of MPEG or non-MPEG decoders depending on the algorithms used to generate the base stream. The base stream decompressor 40 preferably decodes the base stream to generate a video stream 58, and provides it to a display monitor 48. Thus, when the set-top box used by the viewer is not equipped to decode the enhancement stream he or she is still capable of watching the content of the 3D video stream in 2D on the display monitor 48.

The display monitor 48 may include SDTV and/or HDTV. The display monitor 48 may be an analog TV for displaying one or more conventional or non-conventional analog signals. The display monitor 48 also may be a digital TV (DTV) for displaying one or more types of digital video streams, such as, for example, digital visual interface (DVI) compatible video streams.

The enhancement stream decompressor 42 preferably receives the enhancement stream 54 and decodes it to generate a video stream 60. Since the enhancement stream 54 does not contain all the information necessary to re-generate encoded video images, the enhancement stream decompressor 42 preferably receives I-pictures 41 from the base stream decompressor 40 to decode its P-pictures and/or B-pictures. The enhancement stream decompressor 42 preferably transmits the video stream 60 to the video stream post processor 44.

The base stream decompressor 40 preferably also transmits the video stream 58 to the video stream post processor 44. The video stream post processor 44 includes a video stream interleaver for generating a stereoscopic video stream (3D video stream) 62 including left and right views using the video stream 58 and the video stream 60. The stereoscopic video stream 62 preferably is transmitted to a display monitor 46 for 3D display. The stereoscopic video stream 62 preferably includes alternate left and right video fields (or frames) in a time-sequential viewing mode. Therefore, a pair of actively shuttered glasses (not shown), which preferably are synchronized with the alternate interlaced fields (or alternate frames) produced by the display monitor 46, are used for 3D video viewing. For example, conventional Liquid Crystal Display (LCD) shuttered glasses may be used during the time-sequential viewing mode.

In another embodiment, the viewer may be able to select between viewing the 3D images in the time sequential viewing mode or a time-simultaneous viewing mode with dual view 3D systems. In the time-simultaneous viewing mode, the viewer may choose to have the video stream 62 provide only either the left view or the right view rather than a left-right-interlaced stereoscopic view. For example, with the video stream 58 representing the left view and the video stream 62 representing the right view, a dual view 3D system (not shown) may be used to provide 3D video. A typical dual view 3D system may include a pair of miniature monitors mounted on a eyeglass-type frame for stereoscopic viewing of left and right view images.

II. 3D Lens System

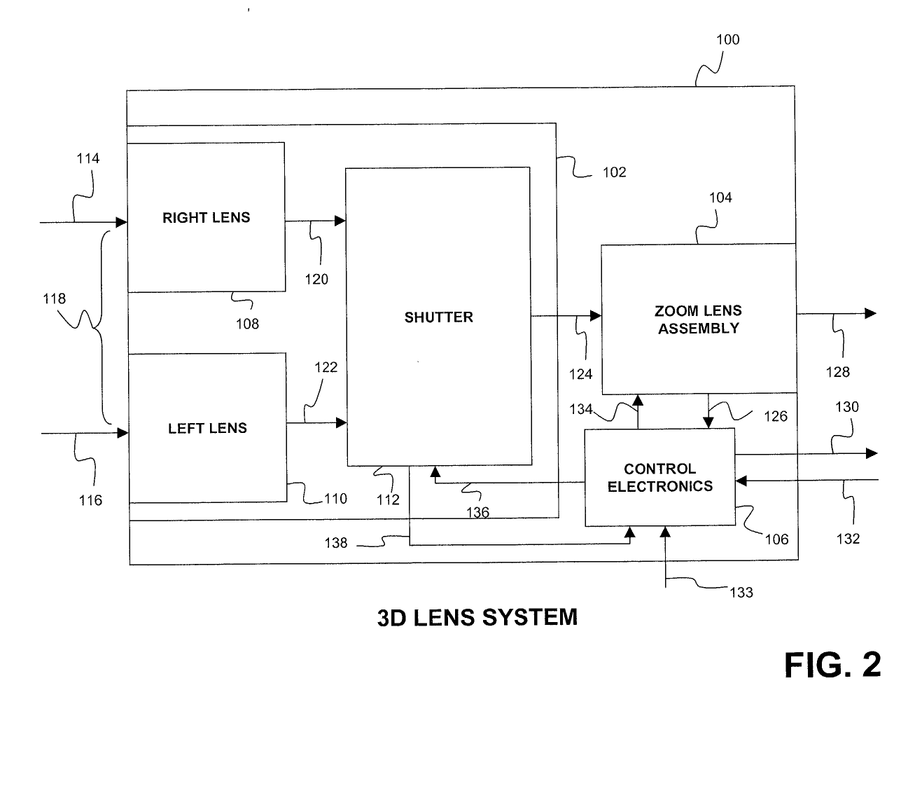

FIG. 2 is a block diagram illustrating one embodiment of a 3D lens system 100 according to this invention. The 3D lens system 100, for example, may be used as the 3D lens system 12 in the 3D video broadcasting system of FIG. 1. The 3D lens system 100 may also be used in a 3D video broadcasting system in other embodiments having a configuration different from the configuration of the 3D video broadcasting system of FIG. 1.

The 3D lens system 100 preferably enables broadcasters to capture stereoscopic (3D) and standard (2D) broadcasts of the same event in real-time, simultaneously with a single camera. The 3D lens system 100 includes a binocular lens assembly 102, a zoom lens assembly 104 and control electronics 106. The binocular lens assembly 102 preferably includes a right objective lens assembly 108, a left objective lens assembly 110 and a shutter 112.

The optical axes or centerlines of the right and left lens assemblies 108 and 110 preferably are separated by a distance 118 from one another. The optical axes of the lenses extend parallel to one another. The distance 118 preferably represents the average human interocular distance of 65 mm. The interocular distance is defined as the distance between the right and left eyes in stereo viewing. In one embodiment, the right and left lens assemblies 108 and 110 are each mounted on a stationary position so as to maintain approximately 65 mm of interocular distance. In other embodiments, the distance between the right and left lenses may be adjusted.

The objective lenses of the 3D lens system project the field of view through corresponding right and left field lenses (shown in FIG. 2 and described in more detail below). The right and left field lenses receive right and left view images 114 and 116, respectively, and image them as right and left optical images 120 and 122, respectively. The shutter 112, also referred to as an optical switch, receives the right and left optical images 120 and 122 and combines them into a single optical image stream 124. For example, the shutter preferably alternates passing either the left image or the right image, one at a time, through the shutter to produce the single optical image stream 124 at the output side of the shutter.

The shuttering action of the shutter 112 preferably is synchronized to video sync signals from the video camera, such as, for example, the video camera 14 of FIG. 1, so that alternate fields of the video stream generated by the video camera contain left and right images, respectively. The video sync signals may include vertical sync signals as well as other synchronization signals. The control electronics 106 preferably use the video sync signals in the automatic control signal 132 to generate one or more synchronization signals to synchronize the shuttering action to the video sync signals, and preferably provides the synchronization signals to the shutter in a shutter control signal 136.

The shutter 112 preferably also orients the left and right views to dynamically select the convergence point of the view that is captured. The convergence point, which may also be referred to as an object point, is the point in space where rays leading from the left and right eyes meet to form a human visual stereoscopic focal point. The 3D video broadcasting system preferably is designed in such a way that (1) the focal point, which is a point in space of lens focus as viewed through the lens optics, and (2) the convergence point coincide independently of the zoom and focus setting of the 3D lens system. Thus, the shutter 112 preferably provides dynamic convergence that is correlated with the zoom and focus settings of the 3D lens system. The convergence of the left and right views preferably is also controlled by the shutter control signal 136 transmitted by the control electronics 106. A shutter feedback signal 138 is transmitted from the shutter to the control electronics to inform the control electronics 106 of convergence and/or other shutter settings.

The zoom lens assembly 104 preferably is designed so that it may be interchanged with existing zoom lenses. For example, the zoom lens assembly preferably is compatible with existing HD broadcast television camera systems. The zoom lens assembly 104 receives the single optical image stream 124 from the shutter, and provides a zoomed optical image stream 128 to the video camera. The single optical image stream 124 has interlaced left and right view images, and thus, the zoomed optical image stream 128 also has interlaced left and right view images.

The control electronics 106 preferably control the binocular lens assembly 102 and the zoom lens assembly 104, and interfaces with the video camera. The functions of the control electronics may include one or more of, but are not limited to, zoom control, focus control, iris control, convergence control, field capture control, and user interface. Control inputs to the 3D lens system preferably are provided via the video camera in the automatic control signal 132 and/or via manual controls on a 3D lens system handgrip (not shown) in a manual control signal 133.

The control electronics 106 preferably transmits a zoom control signal in a control signal 134 to a zoom control motor (not shown) in the zoom lens assembly. The zoom control signal is generated based on automatic zoom control settings from the video camera and/or manual control inputs from the handgrip switches. The zoom control motor may be a gear reduced DC motor. In other embodiments, the zoom control motor may also include a stepper motor. A control feedback signal 126 is transmitted from the zoom lens assembly 104 to the control electronics. The zoom control signal may also be generated based on zoom feedback information in the control feedback signal 126. For example, the control signal 134 may be based on zoom control motor angle encoder outputs, which preferably are included in the control feedback signal 126.

The zoom control preferably is electronically coupled with the interocular distance (between the right and left lenses), focus control and convergence control, such that the zoom control signal preferably takes the interocular distance into account and that changing the zoom setting preferably automatically changes focus and convergence settings as well. In one embodiment of the invention, five discrete zoom settings are provided by the zoom lens assembly 104. In other embodiments, the number of discrete zoom settings provided by the zoom lens assembly 104 may be more or less than five. In still other embodiments, the zoom settings may be continuously variable instead of being discrete.

The control electronics 106 preferably also include a focus control signal as a component of the control signal 134. The focus control signal is transmitted to a focus control motor (not shown) in the zoom lens assembly 104 for lens focus control. The focus control motor preferably includes a stepper motor, but may also include any other suitable motor instead of or in addition to the stepper motor. The focus control signal preferably is generated based on automatic focus control settings from the video camera or manual control inputs from the handgrip switches. The focus control signal may also be based on focus feedback information from the zoom lens assembly 104. For example, the focus control signal may be based on focus control motor angle encoder outputs in the control feedback signal 126. The zoom lens assembly 104 preferably provides a continuum of focus settings.

The control electronics 106 preferably also include an iris control signal as a component of the control signal 134. The iris control signal is transmitted to an iris control motor (not shown) in the zoom lens assembly 104. This control signal is based on automatic iris control settings from the video camera or manual control inputs from the handgrip switches. The iris control motor preferably is a stepper motor, but any other suitable motor may be used instead of or in addition to the stepper motor. The iris control signal may also be based on iris feedback information from the zoom lens assembly 104. For example, the iris control signal may be based on iris control motor angle encoder outputs in the control feedback signal 126.

The convergence control of the shutter 112 preferably is coupled with zoom and focus control in the zoom lens assembly 104 via a correlation programmable read only memory (PROM) (not shown), which preferably implements a mapping from zoom and focus settings to left and right convergence controls. The PROM preferably is also included in the control electronics 106, but it may be implemented outside of the control electronics 106 in other embodiments. For example, zoom/focus inputs from the video camera and/or the hand grip switches and inputs from the left and right convergence control motor angle encoders in the shutter feedback signal 138 preferably are used to generate control signals for the left and right convergence control motors in the shutter control signal 136.

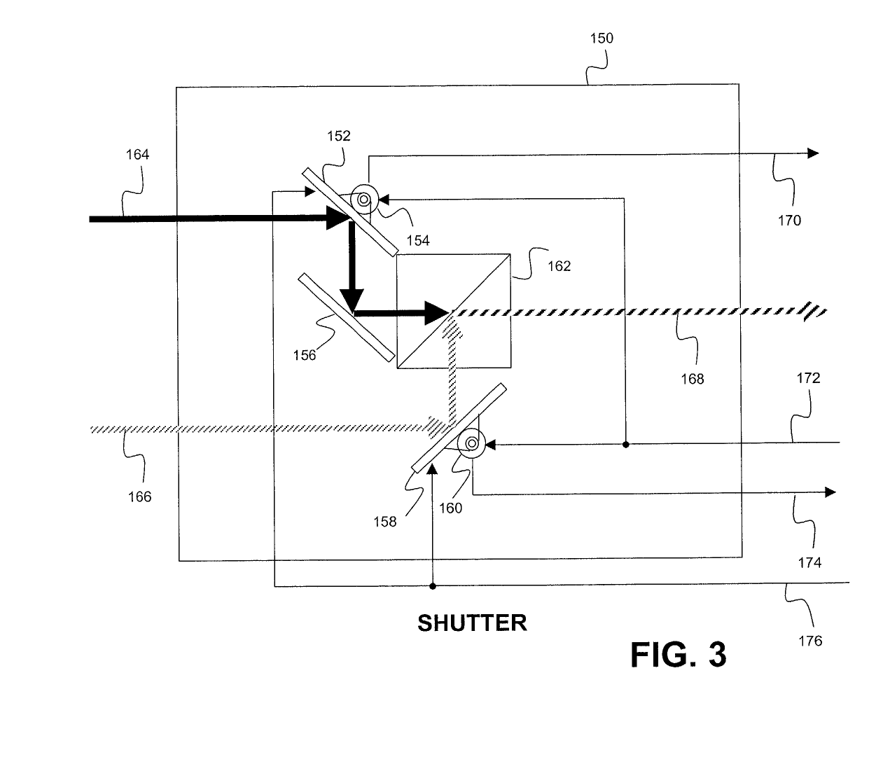

FIG. 3 is a schematic diagram of a shutter 150 in one embodiment of this invention. The shutter 150 may be used in a 3D lens system together with a zoom lens assembly, in which the magnification is selected by lens/mirror movements within the shutter and the zoom lens assembly, while the distance between the image source and the 3D lens system may remain essentially fixed. For example, the shutter 150 may be used in the 3D lens system 100 of FIG. 2. In addition, the shutter 150 may also be used in a 3D lens system having a configuration different from the configuration of the 3D lens system 100.

The shutter 150 includes a right mirror 152, a center mirror 156, a left mirror 158 and a beam splitter 162. The right and left mirrors preferably are rotatably mounted using right and left convergence control motors 154 and 160, respectively. The center mirror 156 preferably is mounted in a stationary position. In other embodiments, different ones of the right, left and center mirrors may be rotatable and/or stationary. The beam splitter 162 preferably includes a cubic prismatic beam splitter. In other embodiments, the beam splitter may include types other than cubic prismatic.

Each of the right and left mirrors 152, 158 preferably includes a micro-mechanical mirror switching device that is able to change orientation of its reflection surface based outside of the control electronics 106 in other embodiments. For example, zoom/focus inputs from the video camera and/or the hand grip switches and inputs from the left and right convergence control motor angle encoders in the shutter feedback signal 138 preferably are used to generate control signals for the left and right convergence control motors in the shutter control signal 136.

FIG. 3 is a schematic diagram of a shutter 150 in one embodiment of this invention. The shutter 150 may be used in a 3D lens system together with a zoom lens assembly, in which the magnification is selected by lens/mirror movements within the shutter and the zoom lens assembly, while the distance between the image source and the 3D lens system may remain essentially fixed. For example, the shutter 150 may be used in the 3D lens system 100 of FIG. 2. In addition, the shutter 150 may also be used in a 3D lens system having a configuration different from the configuration of the 3D lens system 100.

The shutter 150 includes a right mirror 152, a center mirror 156, a left mirror 158 and a beam splitter 162. The right and left mirrors preferably are rotatably mounted using right and left convergence control motors 154 and 160, respectively. The center mirror 156 preferably is mounted in a stationary position. In other embodiments, different ones of the right, left and center mirrors may be rotatable and/or stationary. The beam splitter 162 preferably includes a cubic prismatic beam splitter. In other embodiments, the beam splitter may include types other than cubic prismatic.

Each of the right and left mirrors 152, 158 preferably includes a micro-mechanical mirror switching device that is able to change orientation of its reflection surface based on the control signals 176 provided to the right and left mirrors, respectively. The reflection surfaces of the right and left mirror preferably include an array of micro mirrors that are capable of being re-oriented using an electrical signal. The control signals 176 preferably orient the reflection surface of either the right mirror 152 or the left mirror 158 to provide an optical output 168. At any given time, however, the optical output 168 preferably includes either the right view image or the left view image, and not both at the same time. Therefore, in essence, the micro mechanical switching device on either the right mirror or the left mirror is shut off at a time, and thus, is prevented from contributing to the optical output 168.

The right mirror 152 preferably receives a right view image 164. The right view image 164 preferably has been projected through a right lens of a binocular lens assembly, such as, for example, the right lens 108 of FIG. 2. The right view image 164 preferably is reflected by the right mirror 152, which may include, for example, the Texas Instruments (TI) digital micro-mirror device (DMD).

The TI DMD is a semiconductor-based 1024×1280 array of fast reflective mirrors, which preferably project light under electronic control. Each micro mirror in the DMD may individually be addressed and switched to approximately ±10 degrees within 1 microsecond for rapid beam steering actions. Rotation of the micro mirror in TI DMD preferably is accomplished through electrostatic attraction produced by voltage differences developed between the mirror and the underlying memory cell, and preferably is controlled by the control signals 176. The DMD may also be referred to as a DMD light valve.

The micro mirrors in the DMD may not have been lined up perfectly in an array, and may cause artifacts to appear in captured images when the optical output 168 is captured by a detector, e.g., charge coupled device (CCD) of a video camera. Thus, the video camera, such as, for example, the video camera 14 of FIG. 1 and/or a video stream formatter, such as, for example, the video stream formatter 16 of FIG. 1, may include electronics to digitally correct the captured images so as to remove the artifacts.

In other embodiments, the right and left mirrors 152, 158 may also include other micro-mechanical mirror switching devices. The micro-mechanical mirror switching characteristics and performance may vary in these other embodiments. In still other embodiments, the right and left mirrors may include diffraction based light switches and/or LCD based light switches.

The right view image 164 from the right mirror 152 preferably is reflected to the center mirror 156 and then projected from the center mirror onto the beam-splitter 162. After the right view image 164 exits the beam splitter, it preferably is projected onto a zoom lens assembly, such as, for example, the zoom lens assembly 104 of FIG. 2, and then to a video camera, which preferably is an HD video camera.

A left view image 166 preferably is obtained in a similar manner as the right view image. After the left view image is projected through a left lens, such as, for example, the left lens 110 of FIG. 2, it preferably is then projected onto the left mirror 158. The micro-mechanical mirror switching device, such as, for example, the TI DMD, in the left mirror preferably reflects the left view image to the beam splitter 162.

It is to be noted that the right view image and the left view image preferably are not provided as the optical output 168 simultaneously. Rather, the left and right view images preferably are provided as the optical output 168 alternately using the micro-mechanical mirror switching devices. For example, when the micro-mechanical mirror switching device in the right mirror 152 reflects the right view image towards the beam splitter 162 so as to generate the optical output 168, the micro-mechanical mirror switching device in the left mirror 158 preferably does not reflect the left view image to the beam splitter so as to generate the optical output 168, and vice versa.

It is also to be noted that the distance the right view image 164 travels in its beam path in the shutter 150 out of the beam splitter 162 preferably is identical to the distance the left view image 166 travels in its beam path in the shutter 150 out of the beam splitter 162. This way, the right and left view images preferably are delayed by equal amounts from the time they enter the shutter 150 to the time they exit the shutter 150.

Further, it is to be noted that beam splitters typically reduce the magnitude of an optical input by 50% when providing as an optical output. Therefore, when the shutter 150 is used in a 3D lens system, right and left lenses preferably should collect sufficient light to compensate for the loss in the beam splitter 162. For example, the right and left lenses with increased surface areas and/or larger apertures in the binocular lens assembly may be used to collect light from the image source.

Since the right and left view images are alternately provided as the optical output 168, the optical output 168 preferably includes a stream of interleaved left and right view images. After the optical output exits the beam splitter 162, it preferably passes through the zoom lens assembly to be projected onto a detector in a video camera, such as, for example, the video camera 14 of FIG. 1. The detector may include one or more of a charge coupled device (CCD), a charge injection device (CID) and other conventional or non-conventional image detection sensors. In practice, the video camera 14 may include Sony HDC700A HD video camera.

The control signals 176 transmitted to the right and left mirrors preferably are synchronized to video sync signals provided by the video camera so that alternate frames and/or fields in the video stream generated by the video camera preferably contain right and left view images, respectively. For example, if the top fields of the video stream from a interlaced-mode video camera capturing the optical output 168 include the right view image 164, the bottom fields preferably include the left view image 166, and vice versa. The top and bottom fields may also be referred to as even and odd fields.

The right and left convergence control motors 154 and 160 preferably include DC motors, which may be stepper motors. Convergence preferably is accomplished with the right and left convergence motors, which tilt the right and left mirrors independently of one another, under control of the 3D lens system electronics and based on the output of stepper shaft encoders and/or sensors to regulate the amount of movement. The right and left convergence motors 154, 160 preferably tilt the right and left mirrors 152, 158, respectively, to provide dynamic convergence that preferably is correlated with the zoom and focus settings of the 3D lens system. The right and left convergence control motors 154, 160 preferably are controlled by a convergence control signal 172 from control electronics, such as, for example, the control electronics 106 of FIG. 2. The right and left convergence control motors preferably provide convergence motor angle encoder outputs and/or sensor outputs in feedback signals 170 and 174, respectively, to the control electronics.

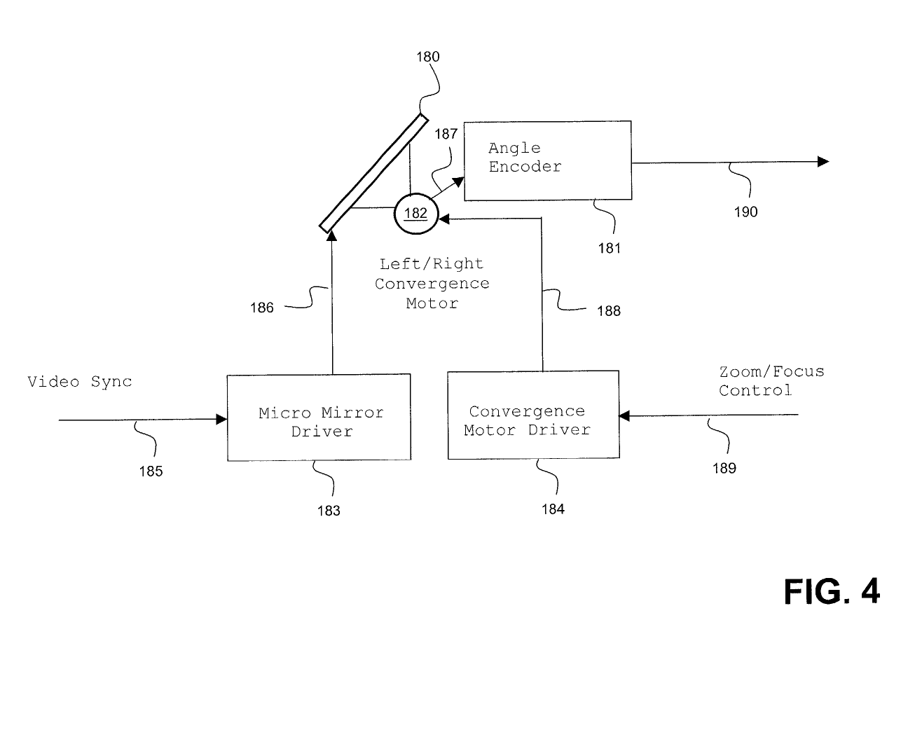

Controls for each of the right and left mirrors 152 and 158 may be described in detail in reference to FIG. 4. FIG. 4 is a schematic diagram illustrating mirror control components in one embodiment of the invention. A mirror 180 of FIG. 4 may be used as either the right mirror 152 or the left mirror 158 of FIG. 3. The mirror 180 preferably includes a micro-mechanical mirror switching device, such as, for example, the TI DMD.

A convergence motor 182 preferably is controlled by the convergence motor driver 184 to tilt the mirror 180 so as to maintain convergence of optical input images while zoom and focus settings are being adjusted. The angle encoder 181 preferably senses the tilting angle of the mirror 180 via a feedback signal 187. The angle encoder 181 preferably transmits angle encoder outputs 190 to control electronics to be used for convergence control.

The convergence control preferably is correlated with zoom/focus settings so that a convergence motor driver 184 preferably receives control signals 189 based on zoom and focus settings. The convergence motor driver 184 uses the control signals 189 to generate a convergence motor control signal 188 and uses It to drive the convergence motor 182.

The micro-mechanical mirror switching device included in the mirror 180 preferably is controlled by a micro mirror driver 183. The micro mirror driver 183 preferably transmits a switching control signal 186 to either shut off or turn on the micro-mechanical mirror switching device. The micro mirror driver 183 preferably receives video synchronization signals to synchronize the shutting off and turning on of the micro mirrors on the micro-mechanical mirror switching device to the video synchronization signals. For example, the video synchronization signals may include one or more of, but are not limited to, vertical sync signals or field sync signals from a video camera used to capture optical images reflected by the mirror 180.

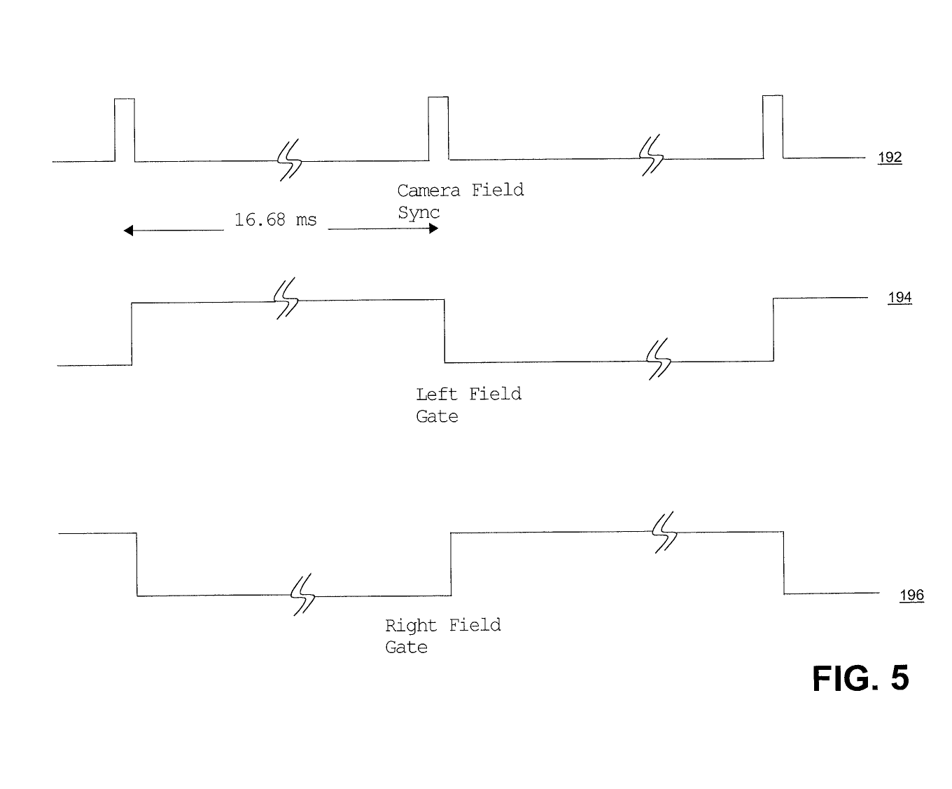

FIG. 5 is a timing diagram which illustrates timing relationship between video camera field syncs 192 and left and right field gate signals 194, 196 used to shut off and turn on left and right mirrors, respectively, in one embodiment of the invention. The video camera field syncs repeat approximately every 16.68 ms, indicating about 60 fields per second or 60 Hz.

In FIG. 5, the left field gate signal 194 is asserted high synchronously to a first video camera field sync. Further, the right field gate signal 196 is asserted high synchronously to a second video camera field sync. When the left field gate signal is high, the left mirror preferably provides the optical output of the shutter. When the right field gate signal is high, the right mirror preferably provides the optical output of the shutter. In FIG. 5, the left field gate signal 194 is de-asserted when the right field gate signal 196 is asserted so as to that optical images from the right and left mirrors do not interfere with one another.

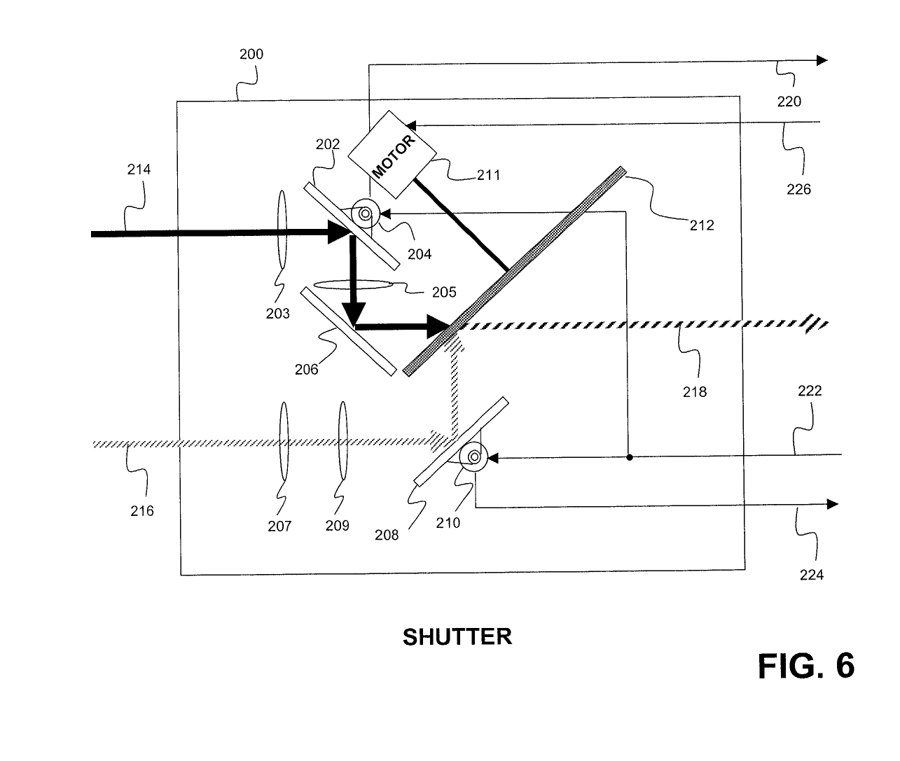

FIG. 6 is a schematic diagram of a shutter 200 in another embodiment of this invention. The shutter 200 may also be used in a 3D lens system, such as, for example, the 3D lens system 100 of FIG. 2. The shutter 200 is similar to the shutter 150 of FIG. 3, except that the shutter 200 preferably includes a rotating disk rather than micro-mechanical mirror switching devices to switch between the right and left view images sequentially in time. The shutter 200 of FIG. 4 includes right and left convergence motors 204, 210, which operate similarly to the corresponding components in the shutter 150. The right and left convergence motors preferably receive a convergence control signal 222 from the control electronics and provide position feedback signals 220 and 224, respectively. As in the shutter 150, the convergence control motors preferably provide dynamic convergence that preferably is correlated with the zoom and focus settings of the 3D lens system.

Right and left mirrors 202 and 208 preferably receive right and left view images 214 and 216, respectively. The right view image preferably is reflected by the right mirror 202, then reflected by a center mirror 206 and then provided as an optical output 218 via a rotating disk 212. The right view image 214 preferably is focused using field lenses 203, 295. The left view image preferably is reflected by a left mirror 208, then provided as the optical output 218 after being reflected by the rotating disk 212. The left view image 216 preferably is focused using field lens 207, 209. Similar to the shutter 150, the optical output 218 preferably includes either the right view image or the left view image, but not both at the same time. As in the case of the shutter 150, the optical path lengths for the right and left view images within the shutter 200 preferably are identical to one another.

The rotating disk 212 is mounted on a motor 211, which preferably is a DC motor being controlled by a control signal 226 from control electronics, such as, for example, the control electronics 106 of FIG. 2. The control signal 226 preferably is generated by the control electronics so that the rotating disk is synchronized to video sync signals from a video camera used to capture the optical output 218. The synchronization between the rotating disk 212 and the video synchronization signals preferably allow alternating frames or fields in the video stream generated by the video camera to include either the right view image or the left view image. For example, if the top fields of the video stream from a interlaced-mode video camera capturing the optical output 218 include the right view image 214, the bottom fields preferably include the left view image 216, and vice versa. For another example, when a progressive-mode video camera is used, alternating frames preferably include right and left view images, respectively.

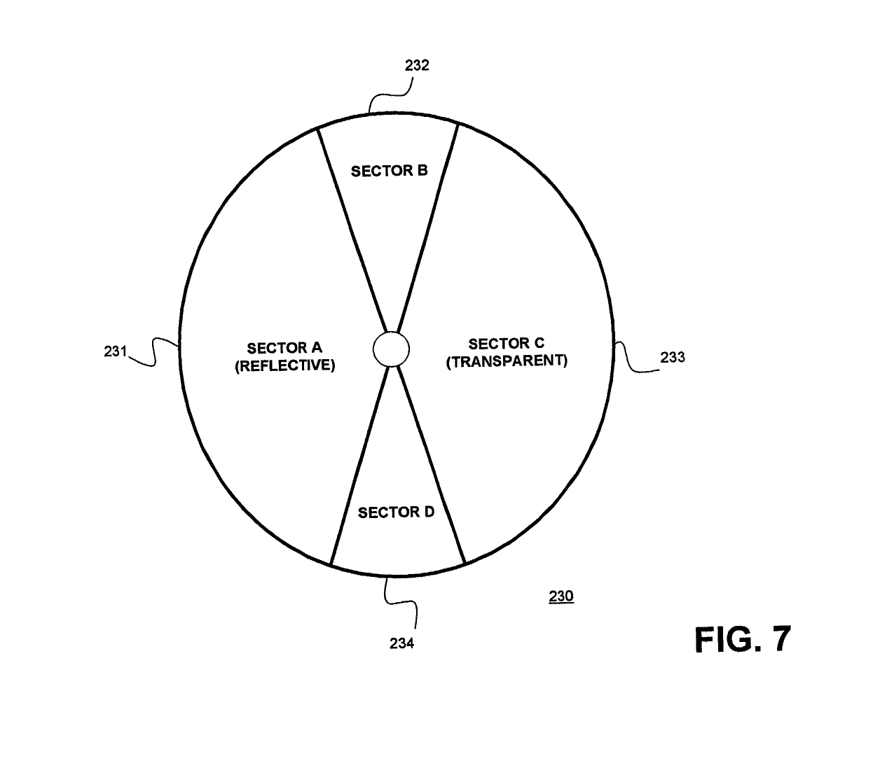

FIG. 7 is a schematic diagram of a rotating disk 230 in one embodiment of this invention. The rotating disk 230, for example, may be used as the rotating disk 212 of FIG. 6. The rotating disk 230 preferably is divided into four sectors. In other embodiments, the rotating disk may have more or less number of sectors. Sector A 231 is a reflective sector such that the left view image 216 preferably is reflected by the rotating disk and provided as the optical output 218 when Sector A 231 is aligned with the optical path of the left view image 216. Sector C 233 preferably is a transparent sector such that the right view image 214 preferably passes through the rotating disk and provided as the optical output when Sector C 233 is aligned with the optical path of the right view image 214. Sectors B and D 232, 234 preferably are neither transparent nor reflective. Sectors B and D 232, 234 are positioned between the Sectors A and C 231, 233 so as to prevent the right and left view images from interfering with one another.

Thus, the embodiments of FIGS. 3 to 7 show shutter systems in the form of an image reflector or beam switching device, both used in a manner akin to a light valve for transmitting time-sequenced images toward or away from the main optical path. These devices, and others apparent to those skilled in the art, are referred to herein as a shutter, but can also be referred to as an optical switch whose function is to switch between right and left images transmitted to a single image stream where the switching rate is controlled by time-sequenced control outputs from the device (e.g., a video camera) to which the lens system is transmitting its stereoscopic images.

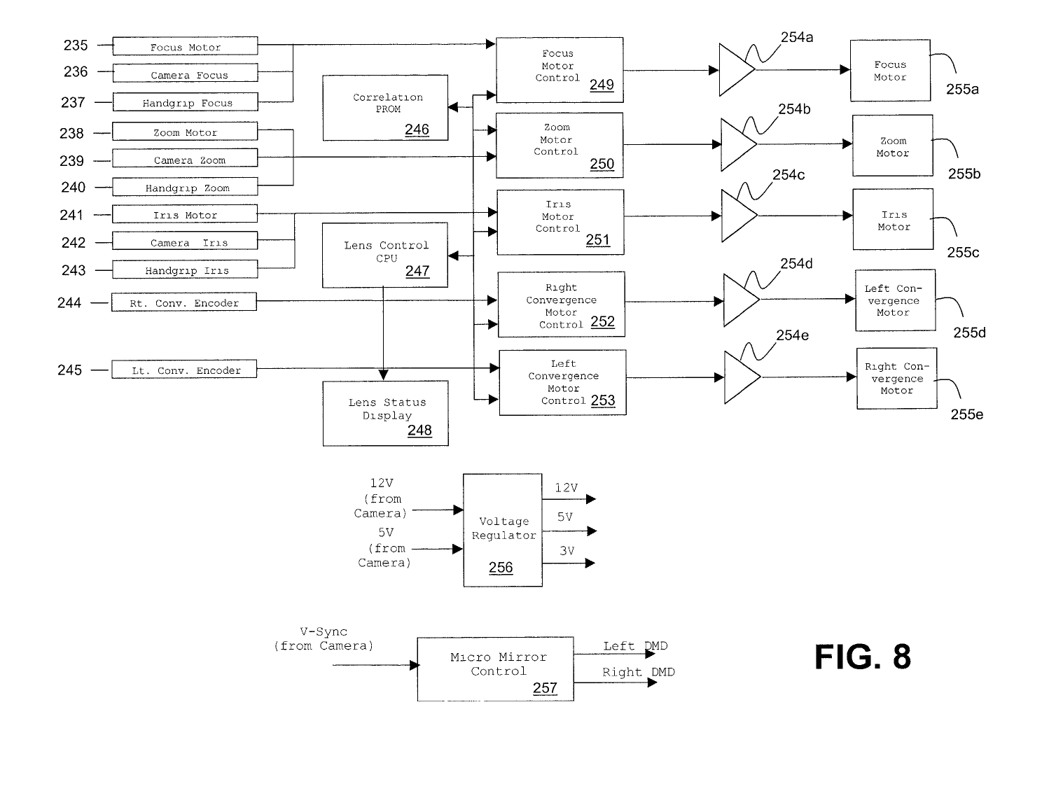

FIG. 8 is a detailed block diagram illustrating functions and interfaces of control electronics, such as, for example, the control electronics 106 in one embodiment of the invention. For example, a correlation PROM 246, a lens control CPU 247, focus control electronics 249, zoom control electronics 250, iris control electronics 251, right convergence control electronics 252, left convergence control electronics 253 as well as micro mirror control electronics 257 may be implemented using a single microprocessor or a micro-controller, such as, for example, a Motorola 6811 micro-controller. They may also be implemented using one or more central processing units (CPUs) , one or more field programmable gate arrays (FPGAs) or a combination of programmable and hardwired logic devices.

A voltage regulator 256 preferably receives power from a video camera, adjusts voltage levels as needed, and provides power to the rest of the 3D lens system including the control electronics. In the embodiment illustrated in FIG. 8, the voltage regulator 256 converts receives 5V and 12V power, then supplies 3V, 5V and 12V power. In other embodiments, input and output voltage levels may be different.

The focus control electronics 249 preferably receive a focus control feedback signal 235, an automatic camera focus control signal 236 and a manual handgrip focus control signal 237, and use them to drive a focus control motor 255a via a driver 254a. The focus control motor 255a, in return, preferably provides the focus control feedback signal 235 to the focus control electronics 249. The focus control feedback signal 235 may be, for example, generated using angle encoders and/or position sensors (not shown) associated with the focus control motor 255a.

The zoom control electronics 250 preferably receive a zoom control feedback signal 238, an automatic camera zoom control signal 239 and a manual handgrip zoom control signal 240, and use them to drive a zoom control motor 255b via a driver 254b. The zoom control motor 255b, in return, preferably provides the zoom control feedback signal 238 to the zoom control electronics 250. The zoom control feedback signal 238 may be, for example, generated using angle encoders and/or position sensors (not shown) associated with the zoom control motor 255b.

The iris control electronics 251 preferably receive an iris control feedback signal 241, an automatic camera iris control signal 242 and a manual handgrip iris control signal 243, and use them to drive an iris control motor 255c via a driver 254c. The iris control motor 255c, in return, preferably provides the iris control feedback signal 241 to the iris control electronics 251. The iris control feedback signal 241 may be, for example, generated using angle encoders and/or position sensors (not shown) associated with the iris control motor 255c.

Right and left convergence control electronics 252, 253 preferably are correlated with the focus control electronics 249, the zoom control electronics 250 and the iris control electronics 251 using a correlation PROM 246. The correlation PROM 246 preferably implements a mapping from zoom, focus and/or iris settings to left and right convergence controls, such that the right and left convergence control electronics 252, 253 preferably adjusts convergence settings automatically in correlation to the zoom, focus and/or iris settings.

Thus correlated, the right and left convergence control electronics 252, 253 preferably drive right and left convergence motors 255d, 255e via drivers 254d and 254e, respectively, to maintain convergence in response to changes to the zoom, focus and/or iris settings. The right and left convergence control electronics preferably receive right and left convergence control feedback signals 244, 245, respectively, for use during convergence control. The right and left convergence control feedback signals, may be, for example, generated by angle encoders and/or position sensors associated with the right and left convergence motors 255d and 255e, respectively.

The correlation between the zoom, focus, iris and/or convergence settings may be controlled by the lens control CPU 247. The lens control CPU 247 preferably provides 3D lens system settings including, but not limited to, one or more of the zoom, focus, iris and convergence settings to a lens status display 248 for monitoring purposes.

The micro mirror control electronics 257 preferably receives video synchronization signals, such as, for example, vertical syncs, from a video camera to generate control signals for micro-mechanical mirror switching devices. In the embodiment illustrated in FIG. 8, right and left DMDs are used as the micro-mechanical mirror switching devices. Therefore, the micro mirror control electronics 257 preferably generate right and left DMD control signals.

III. 3D Video Processing

Returning now to FIG. 1, the stream of optical images 24 preferably is captured by the video camera 14. The video camera 14 preferably generates the video stream 26, which preferably is an HD video stream. The video stream 26 preferably includes interlaced left and right view images. For example, the video stream 26 may include either 1080 HD video stream or 720 HD video stream. In other embodiments, the video stream 26 may include digital or analog video stream having other formats. The characteristics of video streams in 1080 HD and 720 HD formats are illustrated in Table 1. Table 1 also contains characteristics of video streams in ITU-T 601 SD video stream format.

TABLE 1

| VIDEO | | | |
|---|---|---|---|
| PARAMETER | 1080 HD | 720 HD | SD (ITU-T 601) |
| Active Pixels | 1920 (hor) X | 1280 (hor) X | 720 (hor) X |
| | 1080 (vert) | 720 (vert) | 480 (vert) |
| Total Samples | 2200 (hor) X | 1600 (hor) X | 858 (hor) X |
| | 1125 (vert) | 787.5 (vert) | 525 (verr) |
| Frame Aspect | 16:9 | 16:9 | 4:3 |
| Ratio | | | |
| Frame Rates | 60, 30, 24 | 60, 30, 24 | 30 |
| Luminance/ | 4:2:2 | 4:2:2 | 4:2:2 |
| Chrominance | | | |
| Sampling | | | |
| Video Dynamic | >60 dB (10 bits | >60 dB(10 bits | >60 dB(10 bits |
| Range | per sample) | per sample) | per sample) |
| Data Rate | Up to 288 MBps | Up to 133 MBps | Up to 32 MBps |
| Scan Format | Progressive or | Progressive or | Progressive or |
| | Interlaced | Interlaced | Interlaced |

The video stream formatter 16 preferably preprocesses the video stream 26, which may be a digital HD video stream. From here on, this invention will be described in reference to embodiments where the video camera 14 provides a digital HD video stream. However, it is to be understood that video stream formatters in other embodiments of the invention may process SD video streams and/or analog video streams. For example, when the video camera provides analog video streams to the video stream formatter 16, the video stream formatter may include an analog-to-digital converter (ADC) and other electronics to digitize and sample the analog video signal to produce digital video signals.

The pre-processing of the digital HD video stream preferably includes conversion of the HD stream to two SD streams, representing alternate right and left views. The video stream formatter 16 preferably accepts an HD video stream from digital video cameras, and converts the HD video stream to a stereoscopic pair of digital video streams. Each digital video stream preferably is compatible with standard broadcast digital video. The video stream formatter may also provide 2D and 3D video streams during production of the 3D video stream for quality control.

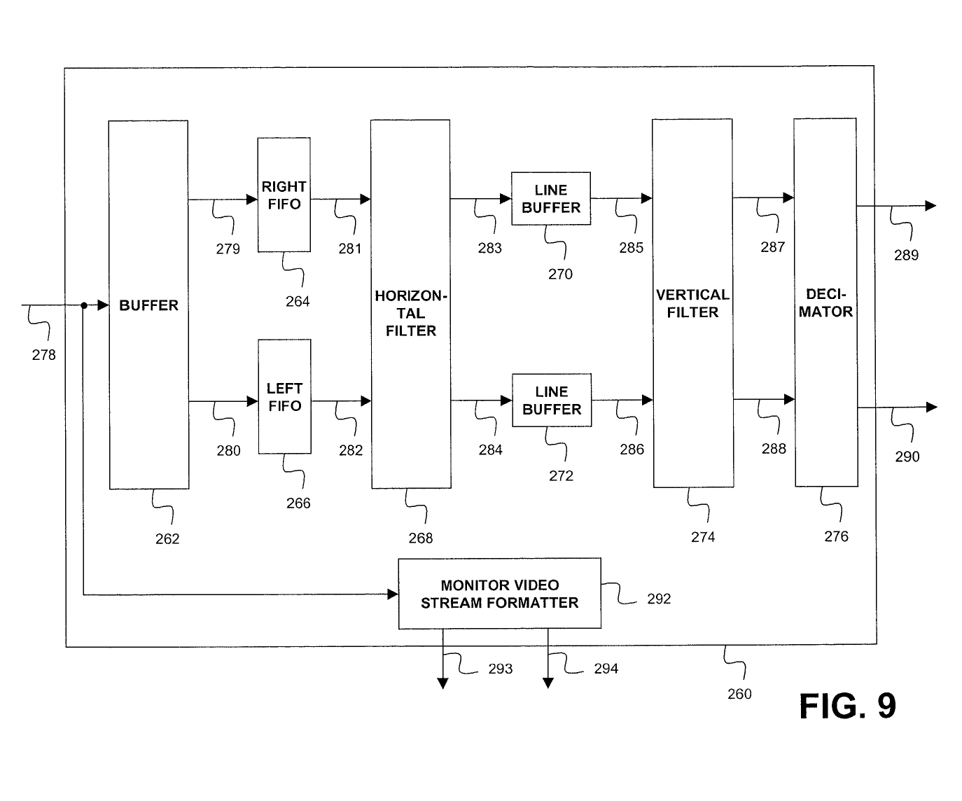

FIG. 9 is a block diagram of a video stream formatter 260 in one embodiment of this invention. The video stream formatter 260, for example, may be similar to the video stream formatter 16 of FIG. 1. The video stream formatter 260 preferably includes a buffer 262, right and left FIFOs 264, 266, a horizontal filter 268, line buffers 270, 272, a vertical filter 274, a decimator 276 and a monitor video stream formatter 292. The video stream formatter 260 may also include other components not illustrated in FIG. 9. For example, the video stream formatter may also include a video stream decompressor to decompress the input video stream in case it has been compressed.

The video stream formatter preferably receives an HD digital video stream 278, which preferably is a 3D video stream containing interlaced right and left view images. The video stream formatter preferably formats the HD digital video stream 278 to provide as a stereoscopic pair of digital video streams 289, 290.

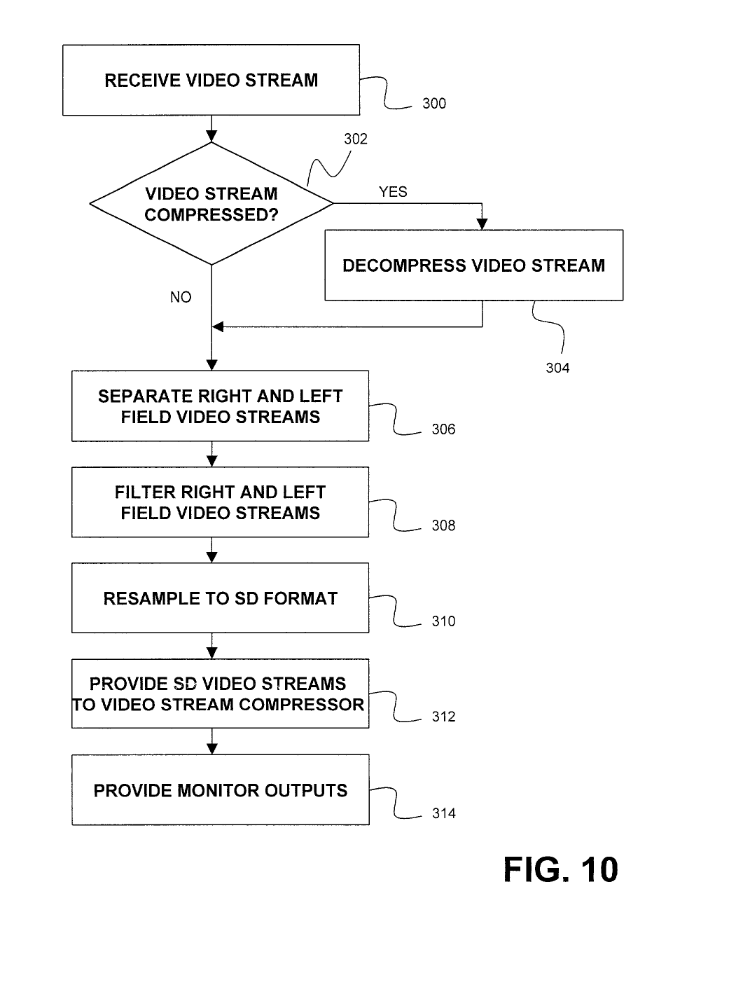

The video stream formatter 260 of FIG. 9 may be described in detail in reference to FIG. 10. FIG. 10 is a flow diagram of pre-processing the HD digital video stream 278 in the video stream formatter 260 in one embodiment of the invention. In step 300, the video stream formatter 260 preferably receives the HD digital video stream 278 from, for example, an HD video camera into the buffer 262. The digital video streams may be in 1080 interlaced (1080i) HD format, 720 interlaced/progressive (720i/720p) HD format, or 480 interlaced/progressive (480i/480p) or any other suitable HD format. The HD digital video stream preferably has been captured using a 3D lens system, such as, for example, the 3D lens system 100 of FIG. 2, and thus preferably includes interlaced right and left field views. For example, the HD digital video stream 278 may also be referred to as a 3D video stream.

In step 302, the video stream formatter may determine if the HD digital video stream 278 has been compressed. For example, professional video cameras, such as Sony HDW700A, may compress the output video stream so as to lower the data rate using compression algorithms, such as, for example, MPEG-2 4:2:2 profile. If the HD digital video stream 278 has been compressed, the video stream formatter preferably decompresses it in step 304 using a video stream decompressor (not shown).

If the HD digital video stream 278 has not been compressed, the video stream formatter 260 preferably proceeds to separate the HD digital video stream into right and left video streams in step 306. In this step, the video stream formatter preferably separates the HD digital video stream into two independent odd/even (right and left) HD field video streams. For example, the right HD field video stream 279 preferably is provided to the right FIFO 264, and the left HD field video stream 280 preferably is provided to the left FIFO 266.

Then in step 308, the right and left field video streams 281, 282 preferably are provided to the horizontal filter 268 for anti-aliasing filtering. The horizontal filter 268 preferably includes a 45 point three-phase anti-aliasing horizontal filter to support re-sampling from 1920 pixels/scan line (1080 HD video stream) to 720 pixels/scan line (SD video stream) . The right and left field video streams may be filtered horizontally by a single 45 point filter or they may be filtered by two or more different 45 point filters.

Then, the horizontally filtered right and left field video streams 283, 284 preferably are provided to line buffers 270, 272, respectively. The line buffers 270, 272 preferably store a number of sequential scan lines for the right and left field video streams to support vertical filtering. In one embodiment, for example, the line buffers may store up to five scan lines at a time. The buffered right and left field video streams 285, 286 preferably are provided to the vertical filter 274. The vertical filter 27/a preferably includes a 40 point eight-phase anti-aliasing vertical to support re-sampling from 540 scan lines/field (1080 HD video stream) to 480 scan lines/image (SD video stream). The right and left field video streams may be filtered vertically by a single 40 point filter or they may be filtered by two or more different 40 point filters.

The decimator 276 preferably includes horizontal and vertical decimators. In step 310, the decimator preferably re-samples the filtered right and left field video streams 287, 288 to form the stereoscopic pair of digital video streams 289, 290, which preferably are two independent SD video streams. The resulting SD video streams preferably have 480 p, 30 Hz format. The decimator 276 preferably converts the right and left field video streams to 720×540 right and left sample field streams by decimating the pixels per horizontal scan line by a ratio of 3/8. Then the decimator 276 preferably converts the 720×540 sample right and left field streams to 720×480 sample right and left field streams by decimating the number of horizontal scan lines by a ratio of 8/9.

Design and application of anti-aliasing filters and decimators are well known to those skilled in the art. In other embodiments, different filter designs may be used for horizontal and vertical anti-aliasing filtering and/or a different decimator design may be used. For example, in other embodiments, filtering and decimating functions may be implemented in a single filter.

In step 312, the SD video streams 289, 290 preferably are provided as outputs to a video stream compressor, such as, for example, the video stream compressor 18 of FIG. 1. The SD video streams preferably represent right and left view images, respectively.

In step 314, the video stream formatter may also provide video outputs for monitoring video quality during production. The monitor video streams preferably are formatted by the monitor video stream formatter 292. The monitor video streams may include a 2D video stream 293 and/or a 3D video stream 294. The monitor video streams may be provided in one or more of, but are not limited to, the following three formats: 1) Stereoscopic 720×483 progressive digital video pair (left and right views); 2) Line-doubled 1920×1080 progressive or interlaced digital video pair (left and right views); 3) Analog 1920×1080, interlaced component video: Y, CR, CB.

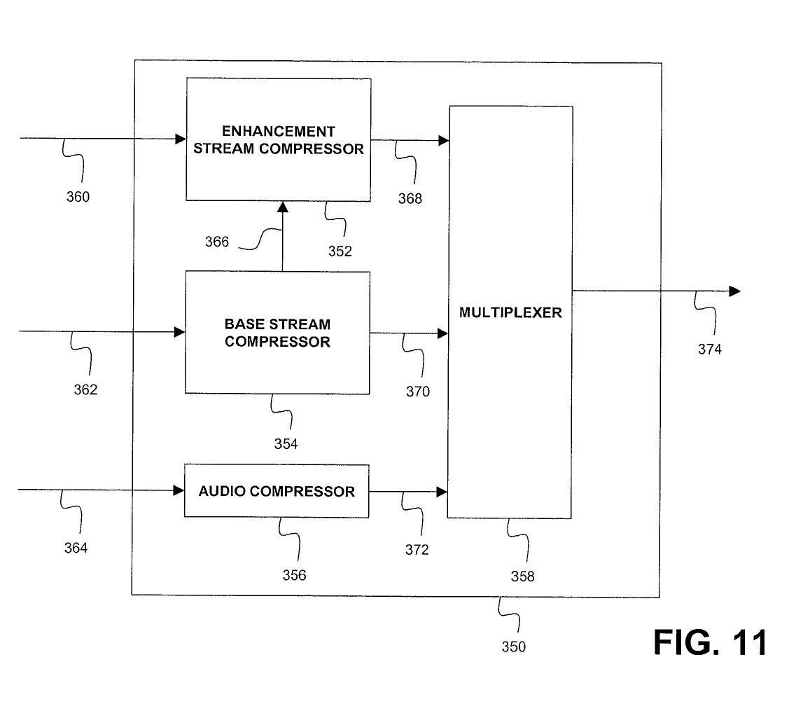

The stereoscopic pair of digital video streams 289, 290 preferably are provided to a video stream compressor, which may be similar, for example, to the video stream compressor 18 of FIG. 1, for video compression. FIG. 11 is a block diagram of a video stream compressor 350, which may be used with the 3D lens system 12 of FIG. 1 as the video stream compressor 18, in one embodiment of the invention. The video stream compressor 350 may also be used with system having other configurations. For example, the video stream compressor 350 may also be used to compress two digital video streams generated by two separate video cameras rather than by a 3D lens system and a single video camera.

The video stream compressor 350 includes an enhancement stream compressor 352, a base stream compressor 354, an audio compressor 356 and a multiplexer 358. The enhancement stream compressor 352 and the base stream compressor 354 may also be referred to as an enhancement stream encoder and a base stream encoder, respectively. Standard decoders in set-top boxes typically recognize and decode MPEG-2 standard streams, but may ignore the enhancement stream.

The video stream compressor 350 preferably receives a stereoscopic pair of digital video streams 360 and 362. Each of the digital video streams 360, 362 preferably includes an SD digital video stream, each of which represents either the right field view or the left field view. Either the right field view video stream or the left field view video stream may be used to generate a base stream. For example, when the left field view video stream is used to generate the base stream, the right field view video stream is used to generate the enhancement stream, and vice versa. The enhancement stream may also be referred to as an auxiliary stream.

The enhancement stream compressor 352 and the base stream compressor 354 preferably are used to generate the enhancement stream 368 and the base stream 370, respectively. The coding method used to generate standard, compatible multiplexed base and enhancement streams may be referred to as “compatible coding”. Compatible coding preferably takes advantage of the layered coding algorithms and techniques developed by the ISO/MPEG-2 standard committee.

In one embodiment of the invention, the base stream compressor preferably receives the left field view video stream 362 and uses standard MPEG-2 video encoding to generate a base stream 370. Therefore, the base stream 370 preferably is compatible with standard MPEG-2 decoders. The enhancement stream compressor may encode the right field view video stream 360 by any means, provided it is multiplexed with the base stream in a manner that is compatible with the MPEG-2 system standard. The enhancement steam 368 may be encoded in a manner compatible with MPEG-2 scalable coding techniques, which may be analogous to the MPEG-2 temporal scalability method.

For example, the enhancement stream compressor preferably receives one or more I-pictures 366 from the base stream compressor 354 for its video stream compression. P-pictures and/or B-pictures for the enhancement stream 368 preferably are encoded using the base stream I-pictures as reference images. Using this approach, one video stream preferably is coded independently, and the other video stream preferably coded with respect to the other video stream which have been independently coded. Thus, only the independently coded view may be decoded and shown on standard TV, e.g., NTSC-compatible SDTV. In other embodiments, other compression algorithms may be used where base stream information, which may include, but not limited to, the I-pictures are used to encode the enhancement stream.

The video stream compressor 350 may also receive audio signals 364 into the audio compressor 356. The audio compressor 356 preferably includes an AC-3 compatible encoder to generate a compressed audio stream 372. The multiplexer 358 preferably multiplexes the compressed audio stream 372 with the enhancement stream 368 and the base stream 370 to generate a compressed 3D digital video stream 374. The compressed 3D digital video stream 374 may also be referred to as a transport stream or an MPEG-2 Transport stream.

In one embodiment of the invention, a video stream compressor, such as, for example, the video stream compressor 18 of FIG. 1, incorporates disparity and motion estimation. This embodiment preferably uses bi-directional prediction because this typically offers the high prediction efficiency of standard MPEG-2 video coding with B-pictures in a manner analogous to temporal scalability with B-pictures. Efficient decoding of the right or left view image in the enhancement stream may be performed with B-pictures using bi-directional prediction. This may differ from standard B-picture prediction because the bi-directional prediction in this embodiment involves disparity based prediction and motion-based prediction, rather than two motion-based predictions as in the case of typical MPEG-2 encoding and decoding.

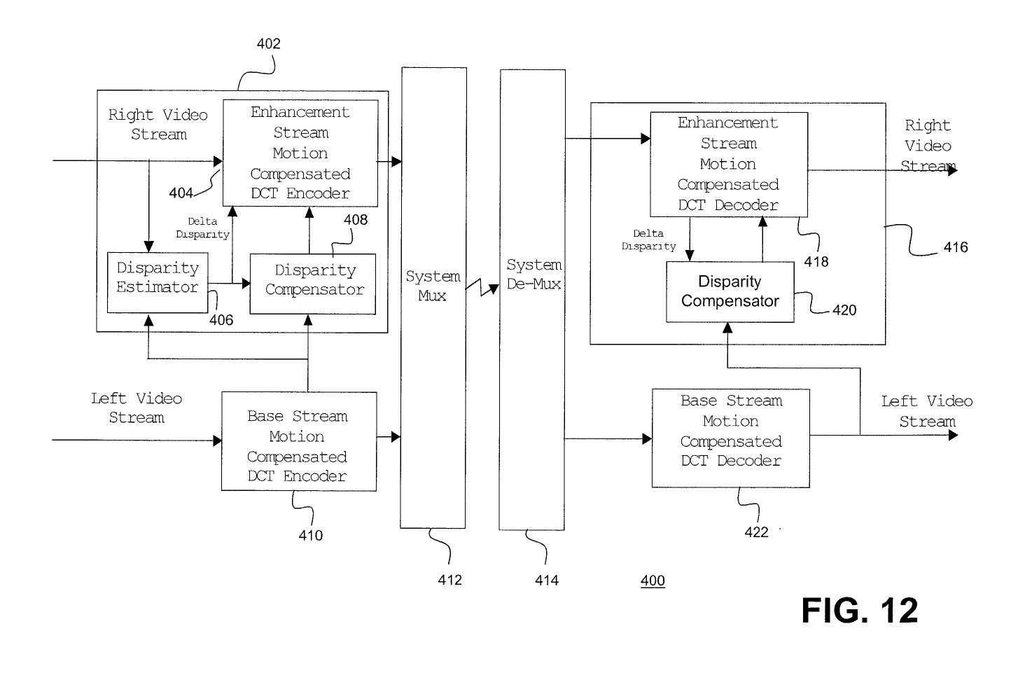

FIG. 12 is a block diagram of a motion/disparity compensated coding and decoding system 400 in one embodiment of this invention. The embodiment illustrated in FIG. 12 encodes the left view video stream in a base stream and right view video stream in an enhancement stream. Of course, it would be just as practical to include the right view video stream in the base stream and left view video stream in the enhancement stream.

The left view video stream preferably is provided to a base stream encoder 410. The base stream encoder 410 preferably encodes the left view video stream independently of the right view video stream using MPEG-2 encoding. The right view video stream in this embodiment preferably uses MPEG-2 layered (base layer and enhancement layer) coding using predictions fifth reference to both a decoded left view picture and a decoded right view picture.

The encoding of the enhancement stream preferably uses B-pictures with two different kinds of prediction, one referencing a decoded left view picture and the other referencing a decoded right view picture. The two reference pictures used for prediction preferably include the left view picture in field order with the right view picture to be predicted and the previous decoded right view picture in display order. The two predictions preferably result in three different modes known in the MPEG-2 standard as forward backward and interpolated prediction.

To implement this type of bi-directional motion/disparity compensated coding, an enhancement encoding block 402 includes a disparity estimator 406 and a disparity compensator 408 to estimate and compensate for the disparity between the left and right views having the same field order for disparity based prediction. The disparity estimator 406 and the disparity compensator 408 preferably receive I-pictures and/or other reference images from the base stream encoder 410 for such prediction. The enhancement encoding block 402 preferably also includes an enhancement stream encoder 404 for receiving the right view video stream to perform motion based prediction and for encoding the right video stream to the enhancement stream using both the disparity based prediction and motion based prediction.

The base stream and the enhancement stream preferably are then multiplexed by a multiplexer 412 at the transmission end and demultiplexed by a demultiplexer 414 at the receiver end. The demultiplexed base stream preferably is provided to a base stream decoder 422 to re-generate the left view video stream. The demultiplexed enhancement stream preferably is provided to an enhancement stream decoding block 416 to re-generate the right view video stream. The enhancement stream decoding block 416 preferably includes an enhancement stream decoder 418 for motion based compensation and a disparity compensator 420 for disparity based compensation. The disparity compensator 420 preferably receives I-pictures and/or other reference images from the base stream decoder 422 for decoding based on disparity between right and left field views.

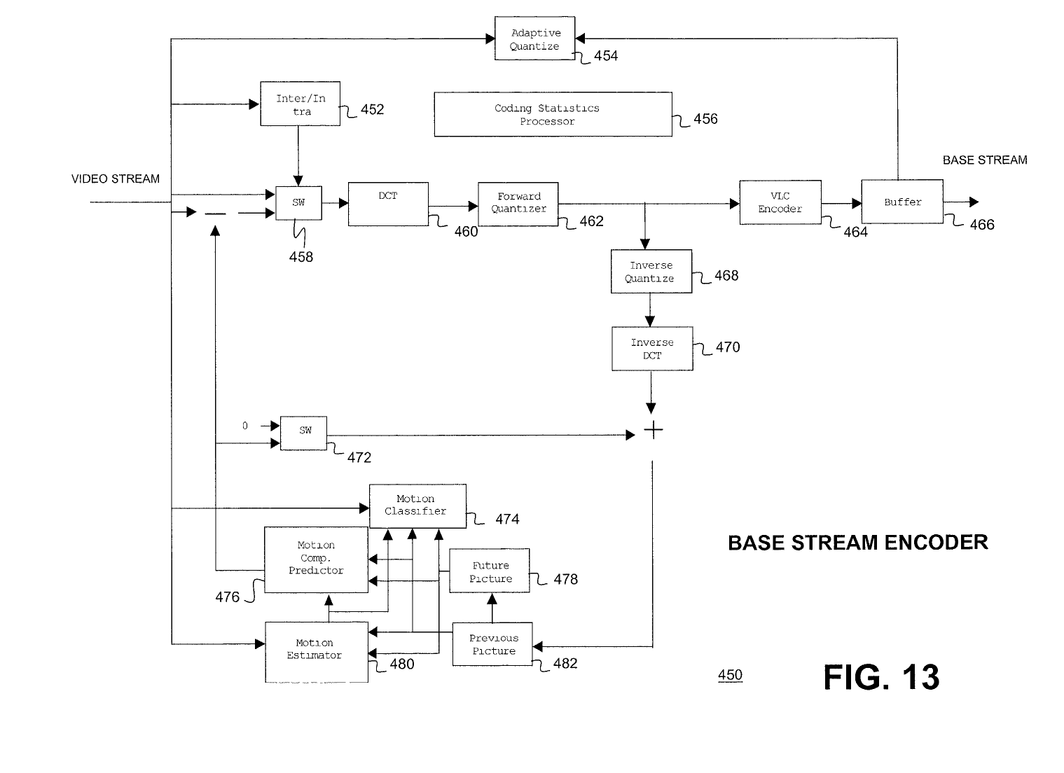

FIG. 13 is a block diagram of a base stream encoder 450 in one embodiment of this invention. The base stream encoder 450 may also be referred to as a base stream compressor, and may be similar to, for example, the base stream compressor 354 of FIG. 11. The base stream encoder 450 preferably includes a standard MPEG-2 encoder. The base stream encoder preferably receives a video stream and generates a base stream, which includes a compressed video stream. In this embodiment both the video stream and the base stream include digital video streams.

An inter/intra block 452 preferably selects between intra-coding (for I-pictures) and inter-coding (for P/B-pictures). The inter/intra block 452 preferably controls a switch 458 to choose between intra- and inter- coding. In intra-coding mode, the video stream preferably is coded by a discrete cosine transform (DCT) block 460, a forward quantizer 462, a variable length coding (VLC) encoder 462 and stored in a buffer 466 in an encoding path for transmission as the base stream. The base stream preferably is also provided to an adaptive quantizer 454. A coding statistics processor 456 keeps track of coding statistics in the base stream encoder 450.

For inter-coding, the encoded (i.e., DCT'd and quantized) picture of the video stream preferably is decoded in an inverse quantizer 468 and an inverse DCT (IDCT) block 470, respectively. Along with input from a switch 472, the decided picture preferably is provided as a previous picture 482 and/or future picture 478 for predictive coding and/or bi-directional coding. For such predictive coding, the future picture 478 and/or the previous picture 482 preferably are provided to a motion classifier 474, a motion compensation predictor 476 and a motion estimator 480. Motion prediction information from the motion compensation predictor 476 preferably is provided to the encoding path for inter-coding to generate P-pictures and/or B-pictures.

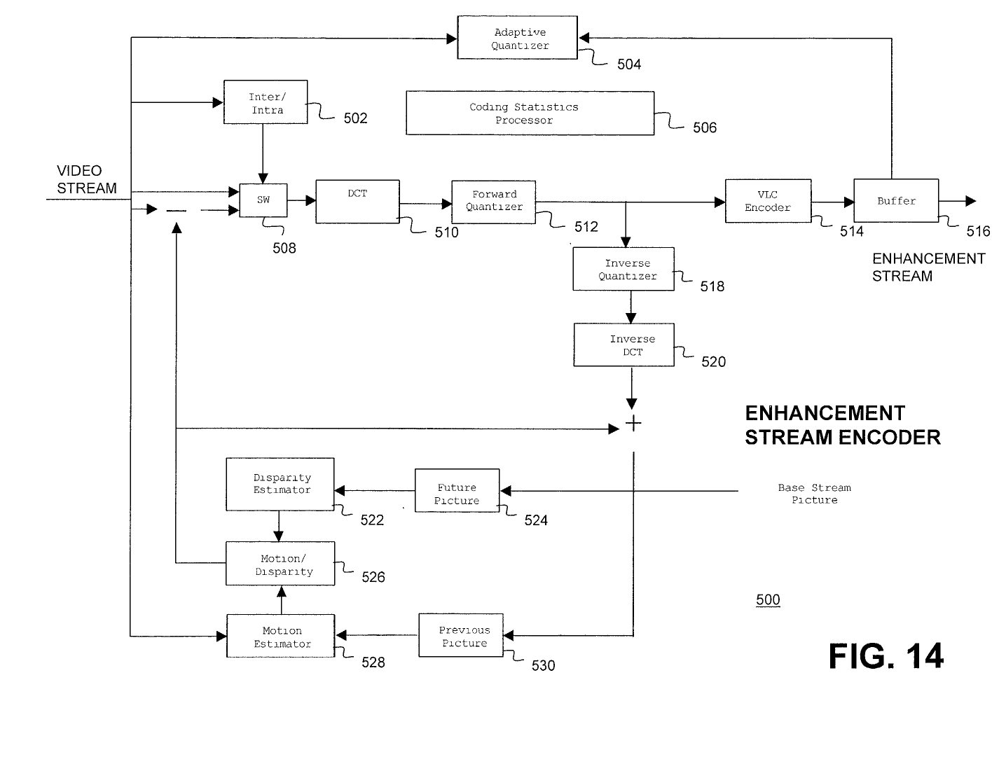

FIG. 14 is a block diagram of an enhancement stream encoder 500 in one embodiment of the invention. The enhancement stream encoder 500 may also be referred to as an enhancement stream compressor, and may be similar to, for example, the enhancement stream compressor 352 of FIG. 11. For example, if the left view video stream is provided to the base stream encoder, the right view video stream preferably is provided to the enhancement stream decoder, and vice versa.

An encoding path of the enhancement stream encoder 500 includes an inter/intra block 502, a switch 508, a DCT block 510, a forward quantizer 512, a VLC encoder 514 and a buffer 516, and operates in a similar manner as the encoding path of the base stream encoder, which may be a standard MPEG-2 encoder. The enhancement stream encoder 500 preferably also includes an adaptive quantizer 504 and a coding statistics processor 506 similar to the base stream encoder 450 of FIG. 13.

The encoded DCT'd and quantized) picture of the video stream preferably is provided to an inverse quantizer 518 and an IDCT block 520 for decoding to be provided as a previous picture 530 for predictive coding to generate P-pictures for example. However, a future picture 524 preferably includes a base stream picture provided by the base stream encoder. The base stream pictures may include I-pictures and/or other reference images from the base stream encoder.

Therefore, for bi-directional coding, a motion estimator 528 preferably receives the previous picture 530 from the enhancement stream, but a disparity estimator 522 preferably receives a future picture 524 from the base stream. Therefore, a motion/disparity compensation predictor 526 preferably uses an I-picture, for example, from the enhancement stream for motion compensation prediction while using an I-picture, for example, from the base stream for disparity compensation prediction.

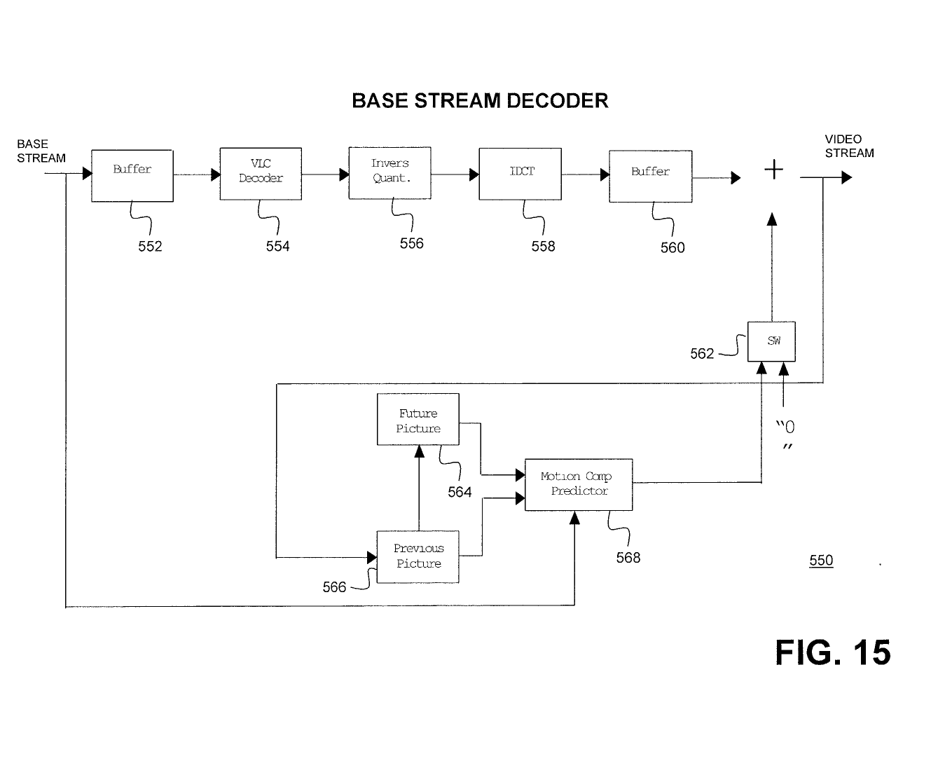

FIG. 15 is a block diagram of a base stream decoder 550 in one embodiment of this invention. The base stream decoder 550 may also be referred to as a base stream decompressor, and may be similar, for example, to the base stream decompressor 40 of FIG. 1. The base stream decoder 550 preferably is a standard MPEG-2 decoder, and includes a buffer 552, a VLC decoder 554, an inverse quantizer 556, an inverse DCT (IDCT) 558, a buffer 560, a switch 562 and a motion compensation predictor 568.

The base stream decoder preferably receives a base stream, which preferably includes a compressed video stream, and outputs a decompressed base stream, which preferably includes a video stream. Decoded pictures preferably are stored as a previous picture 566 and/or a future picture 564 for decoding P-pictures and/or B-pictures.

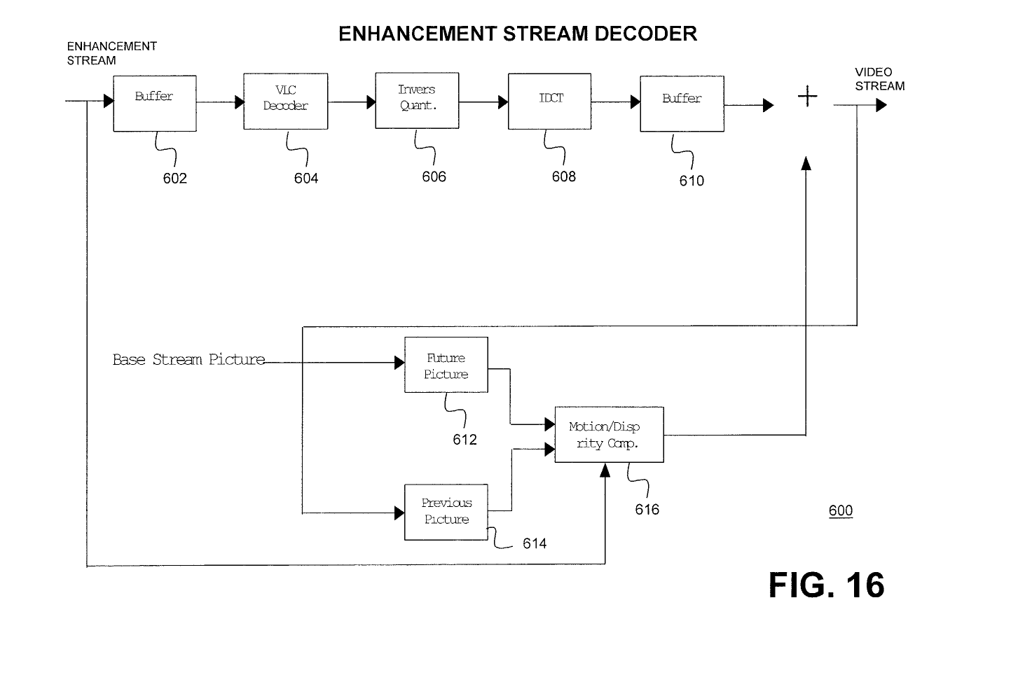

FIG. 16 is a block diagram of an enhancement stream decoder 600 in one embodiment of this invention. The enhancement stream decoder 600 may also be referred to as an enhancement stream decompressor, and may be similar, for example, to the enhancement stream decompressor 42 of FIG. 1. The enhancement stream decoder 600 includes a buffer 602, a VLC decoder 604, an inverse quantizer 606, an IDCT 608, a buffer 610 and a motion/disparity compensator 616. The enhancement stream decoder 600 operates similarly to the base stream decoder 550 of FIG. 15, except that a base stream picture is provided as a future picture 612 for disparity compensation, while a previous picture 614 is used for motion compensation. The motion/disparity compensator 616 preferably performs motion/disparity compensation during bi-directional decoding.

Although this invention has been described in certain specific embodiments, those skilled in the art will have no difficulty devising variations which in no way depart from the scope and spirit of this invention. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

We claim:

1. A video compressor comprising:
a first encoder for receiving a first video stream and for encoding the first video stream; and
a second encoder for receiving a second video stream and for encoding the second video stream,
wherein the first encoder provides information related to the first video stream to the second encoder to be used during the encoding of the second video stream.

2. The video compressor of claim 1 further comprising a multiplexer for receiving and multiplexing the encoded first video stream and the encoded second video stream to generate a compressed 3D video stream.

3. The video compressor of claim 1 wherein the first video stream includes one selected from a group consisting of a right view video stream and a left view video stream, and the second video stream includes either the right view or the left view video stream, whichever is not included in the first video stream.

4. The video compressor of claim 3 wherein the left and right view video streams have been generated by a single camera using a 3D lens system for interleaving right and left view images to generate a single stream of optical images.

5. The video compressor of claim 3 wherein the right view video stream has been generated using a right view video camera and the left view video stream has been generated using a left view video camera.

6. The video compressor of claim 1 wherein the first encoder includes an MPEG encoder, the first video stream is encoded to an MPEG video stream, and the second encoder receives one or more decoded pictures, and
wherein the second encoder uses the decoded pictures from the first video stream for disparity estimation and one or more decoded pictures from the second video stream for motion estimation, during bi-directional coding of the second video stream.

7. A method of compressing video, the method comprising the steps of:
receiving a first video stream;
receiving a second video stream;
encoding the first video stream; and
encoding the second video stream using information related to the first video stream.

8. The method of claim 7 further comprising the step of multiplexing the encoded first video stream and the encoded second video stream to generate a compressed 3D video stream.

9. The method of claim 7 wherein the first video stream includes one selected from a group consisting of a right view video stream and a left view video stream, and the second video stream includes either the right view or the left view video stream, whichever is not included in the first video stream.

10. The method of claim 7 wherein the step of encoding the first video stream comprises the step of MPEG encoding the first video stream to generate an MPEG video stream, and wherein the step of encoding the second video stream comprises the steps of:
receiving one or more decoded pictures from the first video stream;
performing disparity estimation using the decoded pictures from the first video stream;
encoding and decoding one or more pictures from the second video stream;
performing motion estimation using the decoded pictures from the second video stream; and
generating one or more B-pictures, based on disparity difference and motion difference, from the second video stream.

11. A 3D video displaying system comprising:
a demultiplexer for receiving a compressed 3D video stream, and for extracting a first compressed video stream and a second compressed video stream from the compressed 3D video stream;
a first decompressor for decoding the first compressed video stream to generate a first video stream;
a second decompressor for decoding the second compressed video stream using information related to the first compressed video stream to generate a second video stream.

12. The 3D video displaying system of claim 11 wherein the first decompressor includes an MPEG decoder, the first video stream includes one or more decoded first pictures, and the second video stream includes one or more decoded second pictures, and
wherein the second decompressor receives the decoded first pictures from the first decompressor, uses the decoded first pictures for disparity compensation, and uses the decoded second pictures for motion compensation.

13. The 3D video displaying system of claim 11 wherein the first video stream includes one selected from a group consisting of a right view video stream and a left view video stream, and the second video stream includes either the right view or the left view video stream, whichever is not included in the first video stream.

14. The 3D video displaying system of claim 11 further comprising a first display device, wherein the first video stream is provided to the first display device for display.

15. The 3D video displaying system of claim 11 further comprising a video interleaver for receiving the first video stream and the second video stream, and for interleaving the first video stream and the second video stream to generate a 3D video stream.

16. The 3D video displaying system of claim 15 further comprising a display device and LCD shuttered glasses, wherein the 3D video stream is displayed on the display device, and even and odd fields of the 3D video stream are viewed alternately by right and left eyes, respectively, using LCD shuttered glasses.

17. The 3D video displaying system of claim 11 further comprising first and second display devices, wherein the first video stream is displayed on the first display device, and the second video stream is displayed on the second display device, and wherein the first display device is viewed by a first eye of a viewer and the second display device is viewed by a second eye of the viewer.

18. A method of processing a compressed 3D video stream, the method comprising the steps of:
receiving the compressed 3D video stream;
demultiplexing the compressed 3D video stream to extract a first compressed video stream and a second compressed video stream;
decoding the first compressed video stream to generate a first video stream; and
decoding the second compressed video stream using information related to the first compressed video stream to generate a second video stream.

19. The method of claim 18 wherein the first video stream includes one or more decoded first pictures and the second video stream includes one or more decoded second pictures, and
wherein the step of decoding the second compressed video stream comprises the steps of: receiving the decoded first pictures from the first video stream; performing disparity compensation using the decoded first pictures; and performing motion compensation using the decoded second pictures.

20. The method of claim 18 wherein the first video stream includes one selected from a group consisting of a right view video stream and a left view video stream, and the second video stream includes either the right view or the left view video stream, whichever is not included in the first video stream.

21. The method of claim 20 further comprising the step of displaying the first video stream on a display device.

22. The method of claim 18 further comprising the step of interleaving the first video stream and the second video stream to generate a 3D video stream.

23. The method of claim 22 further comprising the step of displaying the 3D video stream on a display device, and wherein even and odd fields of the 3D video stream are viewed alternately by right and left eyes, respectively, using LCD shuttered glasses.

24. The method of claim 18 wherein the first video stream is displayed on a first display device and the second video stream is displayed on a second display device, and wherein the first display device is viewed by a first eye of a viewer and the second display device is viewed by a second eye of the viewer.

25. A 3D video broadcasting system comprising:
a video compressor for receiving right and left view video streams, and for generating a compressed 3D video stream; and
a set-top receiver for receiving the compressed 3D video stream and for generating a 3D video stream,
wherein the compressed 3D video stream comprises a first compressed video stream and a second compressed video stream, and wherein the second compressed video stream has been encoded using information from the first compressed video stream.

26. The 3D video broadcasting system of claim 25 further comprising a 3D lens system for generating an optical output, the optical output including interleaved left and right view images.

27. The 3D video broadcasting system of claim 26 further comprising an HD digital video camera, wherein the HD digital video camera receives the optical output and generates a 3D digital video stream.

28. The 3D video broadcasting system of claim 27 further comprising a video stream formatter for filtering and re-sampling the 3D digital video stream to generate a stereoscopic pair of standard definition (SD) digital video streams to provide as the right and left view video streams.

29. The 3D video broadcasting system of claim 28 wherein the video stream formatter generates at least one selected from a group consisting of a 2D video stream and a 3D video stream to be used for monitoring quality during production of the 3D digital video stream.

30. The 3D video broadcasting system of claim 25 wherein at least one bi-directional picture (B-picture) in the second compressed video stream have been encoded using an intra picture (I-picture) from the first compressed video stream for disparity compensation coding and an I-picture from the second compressed video stream for motion compensation coding.

31. A 3D video broadcasting system comprising:
compressing means for receiving and encoding right and left view video streams to generate a compressed 3D video stream; and
decompressing means for receiving and decoding the compressed 3D video stream to generate a 3D video stream,
wherein the compressed 3D video stream comprises a first compressed video stream and a second compressed video stream, and wherein the second compressed video stream has been encoded using information from the first compressed video stream.

32. The 3D video broadcasting system of claim 31 further comprising means for generating an optical output including interleaved left and right view images.
